(19) United States
(12) Patent Application Publication
(10) Pub. No.: US 2015/0339624 A1
(43) Pub. Date: Nov. 26, 2015

(54) SYSTEMS AND METHODS FOR DEVICE-BASED CARRIER VERIFICATION IN A FREIGHT TRANSPORTATION NETWORK

(71) Applicant: Trakkx.com, LLC, Encinitas, CA (US)

(72) Inventor: John Lozito, Encinitas, CA (US)

(21) Appl. No.: 14/712,677

(22) Filed: May 14, 2015

Related U.S. Application Data
(60) Provisional application No. 61/993,020, filed on May 14, 2014.

(51) Int. Cl. G06Q 10/08

(52) U.S. Cl. CPC G06Q 10/0833

(57) ABSTRACT

Computer-implemented systems, and methods of using the same, for freight carrier verification comprising: a database of freight carriers, freight transport equipment, and/or an operator; a database of freight transport orders, each order comprising an associated carrier; a device attached to, associated with, or operably connected to freight transport equipment and configured to transmit freight transport equipment information; a device attached to, associated with, or operably connected to freight transport equipment and configured to transmit operator biometric information; and a software module configured to generate a shared portal that displays information associated with the orders including the carrier, the equipment, the operator, and/or the biometric information, provided that the portal is accessible to all users associated with an order.

### CROSS-REFERENCE

This application claims the benefit of U.S. Provisional Application No. 61/993,020, filed May 14, 2014, which is incorporated herein by reference.

### BACKGROUND OF THE INVENTION

In the freight transportation industry shippers have cargo which they need to have shipped, carriers provide the transportation services to move the cargo between the pickup and destination locations, and receivers in turn receive the cargo sent by the shipper.

### SUMMARY OF THE INVENTION

Currently, during transit there is no system which can guarantee to the shipper (or the receiver) that the operator and equipment contracted to provide the transport services are in fact those actually performing the service. Agreed upon operators (i.e., drivers, etc.) and equipment (e.g., trucks, trailers, tractors, containers, aircraft, watercraft etc.) may be substituted or whole services may be subcontracted out to third parties, unbeknownst to the critical players, including customers, involved. This situation potentially results in shippers or receivers contracting for services with reputable carriers only to find that their cargo has been handled by less desirable carriers. Worse still, they may find out well after the fact or not at all.

There is a long felt and unmet need for a carrier verification system including a shared portal which displays information that is not carrier-owned. The data integrity of such information is higher than that currently available because carriers are prevented from manipulating the data. In an effective carrier verification system, information does not flow to the carrier before being passed on to the other stakeholders (e.g., shippers, receivers, etc.). In an effective carrier verification system, all users associated with an order can monitor the status of the order itself as it evolves (e.g., “order entered,” “carrier booked,” “equipment dispatched,” “loaded,” etc.) as well as a range of real-time telemetry information (e.g., current cargo location, speed, direction, freight temperature, etc.). With the exception of proprietary accounting information, all participants in a transaction may view this data in a shared and open way.

The inventor has also identified a need for a carrier verification system that offers a constant and real-time data feed of multiple telemetry parameters as the freight is in transit. The inventor has identified that an effective carrier verification system should also gather, process, and transmit telemetry data to a shared portal via proprietary hardware which is installed onto equipment (e.g., trucks, trailers, tractors, containers, aircraft, watercraft etc.).

Current freight tracking systems fail to offer functionality to ensure that the operator of record will be the actual operator and the equipment contracted is actually used in performing the transport of the freight. An effective carrier verification system should verify operator and equipment integrity in two ways. First, operator integrity should be verified by biometric data collected at various points throughout transit, matched against verified operator records, and made available to all transaction parties via a portal. Second, equipment integrity should be verified by hardware that is semi-permanently or permanently attached to the transport equipment.

In one aspect, disclosed herein are computer-implemented systems for freight carrier verification comprising: a database of freight carriers, freight transport equipment, and operators; a database of freight transport orders, each order comprising an associated carrier; a device attached to or associated with freight transport equipment and configured to transmit, receive, or store freight transport equipment information; a device attached to, associated with, or operably connected to freight transport equipment and configured to transmit, receive, or store operator biometric information; and a software module configured to generate a shared portal that displays information associated with the orders including the carrier, the equipment, the operator, and the biometric information, wherein the portal is accessible to all users associated with an order. In some embodiments, each carrier is identified by an operating authority or a USDOT number. In some embodiments, each order further comprises an associated freight transport equipment and operator. In some embodiments, the system further comprises a software module configured to administer the system, wherein the module configured to administer the system allows addition, modification, and deletion of carrier, equipment, and operator information. In some embodiments, freight transport equipment comprises at least one of: tractors, trailers, shipping containers, rail cars, aircraft, and/or watercraft. In some embodiments, operator identification comprises at least one of: name, license state, license number, operating history, and/or biometric information. In some embodiments, biometric information comprises a fingerprint. In some embodiments, an order is created by a shipper or a receiver. In some embodiments, freight transport equipment information comprises equipment identity. In some embodiments, freight transport equipment information comprises telemetry information. In further embodiments, telemetry information comprises at least one of: location, speed, direction, and/or altitude. In further embodiments, the telemetry information comprises at least one of: freight temperature, freight humidity, freight atmospheric pressure, freight vibration, freight shock, freight ambient light, and/or door status. In some embodiments, the system further comprises a software module for graphing or charting telemetry information over a period of time. In some embodiments, the device configured to transmit freight transport equipment information is attached to, associated with, or operably connected to a tractor, a trailer, both a tractor and a trailer, a shipping, container, a rail car, an aircraft, and/or a watercraft. In some embodiments, the device configured to transmit freight transport equipment information utilizes a GPS chip and GSM modem. In some embodiments, the device configured to transmit operator biometric information comprises a fingerprint reader. In some embodiments, a portal comprises a web application. In further embodiments, a portal is implemented as software-as-a-service (SaaS). In some embodiments, a portal comprises a mobile application. In some embodiments, a portal displays the method by which each device configured to transmit freight transport equipment information was or is attached to, associated with, or operably connected to freight transport equipment. In further embodiments, portal displays the last inspection date for each device configured to transmit freight transport equipment information. In some embodiments, a portal displays telemetry information on a map. In further embodiments, portal displays telemetry information on a map in the form of a breadcrumb trail. In still further embodiments, each breadcrumb comprises telemetry information. In some embodiments, a portal displays a projected arrival date and time. In some embodiments, users associated with an order include at least one of: a shipper, a carrier, a broker, an operator, a receiver, and an insurer. In some embodiments, the system further comprises an array of sensors. In further embodiments, the sensors are wireless. In still further embodiments, the sensors communicate with a sensor hub. In still further embodiments, the sensors and hub form a hub and spoke network. In some embodiments, the system further comprises a software module for defining a geofence associated with at least one of: a freight pick-up location, a way point, and a freight drop-off location. In further embodiments, a geofence is utilized to automatically update the status of freight transport equipment. In still further embodiments, status of freight transport equipment is at least one of: available, booked, dispatched, arrived at pick up, loaded, arrived at drop off, drop, and empty. In some embodiments, the system further comprises a software module for scoring at least one of: carriers, operators, brokers, shippers, and receivers. In further embodiments, scoring is reported as a report card comprising at least one of: pick-up exceptions, drop-off exceptions, arrival exceptions, freight integrity exceptions, shipper reviews, and receiver reviews.

In another aspect, disclosed herein are computer readable storage media encoded with a computer program including instructions executable by a processor to create a freight carrier verification application comprising: a database of freight carriers, freight transport equipment, and operators; a database of freight transport orders, each order comprising an associated carrier; a software module configured to receive or transmit freight transport equipment information associated with an order; a software module configured to receive or transmit operator biometric information associated with an order; and a software module configured to generate a shared portal that displays information associated with the orders including the carrier, the equipment, the operator, and the biometric information, wherein the portal is accessible by all users associated with an order. In some embodiments, each carrier is identified by an operating authority or a USDOT number. In some embodiments, each order further comprises an associated freight transport equipment and operator. In some embodiments, the application further comprises a software module configured to allow addition, modification, and deletion of carrier, equipment, and operator information. In some embodiments, freight transport equipment comprises at least one of: tractors, trailers, shipping containers, rail cars, aircraft, and watercraft. In some embodiments, operator identification comprises at least one of: name, license state, license number, operating history, and biometric information. In some embodiments, biometric information comprises at least one fingerprint. In some embodiments, an order is created by a shipper or a receiver. In some embodiments, freight transport equipment information comprises equipment identity. In some embodiments, freight transport equipment information comprises telemetry information. In further embodiments, the telemetry information comprises at least one of: location, speed, direction, and altitude. In further embodiments, the telemetry information comprises at least one of: freight temperature, freight humidity, freight atmospheric pressure, freight vibration, freight shock, freight ambient light, and door status. In some embodiments, the application further comprises a software module for graphing or charting telemetry information over a period of time. In some embodiments, the software module configured to receive freight transport equipment information associated with an order receives information transmitted from a device attached to, associated with, or operably connected to a tractor, a trailer, both a tractor and a trailer, a shipping container, a rail car, an aircraft, or a watercraft. In some embodiments, the software module configured to receive operator biometric information associated with an order receives information transmitted from a device attached to, associated with, or operably connected to a tractor, a trailer, both a tractor and a trailer, a shipping container, a rail car, an aircraft, or a watercraft. In some embodiments, the portal comprises a web application. In further embodiments, the portal is implemented as software-as-a-service (SaaS). In some embodiments, the portal comprises a mobile application. In some embodiments, the portal displays the method by which each device transmitting freight transport equipment information was attached to, associated with, or operably connected to freight transport equipment. In some embodiments, the portal displays the last inspection date for each device transmitting freight transport equipment information. In some embodiments, the portal displays telemetry information on a map. In further embodiments, the portal displays telemetry information on a map in the form of a breadcrumb trail. In still further embodiments, each breadcrumb comprises telemetry information. In some embodiments, the portal displays a projected arrival date and time. In some embodiments, the users associated with an order include at least one of: a shipper, a carrier, a broker, an operator, a receiver, and an insurer. In some embodiments, the application further comprises a software module configured to receive freight integrity information from an array of sensors attached to, associated with, or operably connected to freight transport equipment. In further embodiments, the sensors communicate with a sensor hub. In still further embodiments, the sensors and hub form a hub and spoke network. In some embodiments, the application further comprises a software module for defining a geofence associated with at least one of: a freight pick-up location, a way point, and a freight drop-off location. In further embodiments, a geofence is utilized to automatically update the status of freight transport equipment. In still further embodiments, a status of freight transport equipment is at least one of: available, booked, dispatched, arrived at pick up, loaded, arrived at drop off, drop, and empty. In some embodiments, the application further comprises a software module for scoring at least one of: carriers, operators, brokers, shippers, and receivers. In further embodiments, the scoring is reported as a report card comprising at least one of: pick-up exceptions, drop-off exceptions, arrival exceptions, freight integrity exceptions, shipper reviews, and receiver reviews.

In another aspect, disclosed herein are computer-implemented methods comprising the steps of: maintaining a database of freight carriers, freight transport equipment, and operators in a computer memory; receiving, by a computer, an order for freight transport, wherein the order comprises a freight carrier; monitoring, by the computer, transmissions from a device attached to, associated with, or operably connected to freight transport equipment and configured to transmit freight transport equipment information; monitoring, by the computer, transmissions from a device attached to, associated with, or operably connected to freight transport equipment and configured to transmit operator biometric information; and generating, by the computer, a shared portal that displays information associated with the order including the carrier, the equipment, the operator, and the biometric information, wherein the portal is accessible by all users associated with an order. In some embodiments, each carrier is identified by an operating authority or a USDOT number. In some embodiments, an order further comprises freight transport equipment and an operator. In some embodiments, the method further comprises the step of conducting an inspection of the device attached to, associated with, or operably connected to freight transport equipment and configured to transmit freight transport equipment information. In some embodiments, the method further comprises the step of conducting an inspection of the device attached to, associated with, or operably connected to freight transport equipment and configured to transmit operator biometric information. In some embodiments, the freight transport equipment is a tractor, a trailer, a shipping container, a rail car, an aircraft, or a watercraft. In some embodiments, the freight transport equipment information comprises telemetry information. In some embodiments, the telemetry information comprises at least one of: location, speed, direction, and altitude. In some embodiments, the telemetry information comprises at least one of: freight temperature, freight humidity, freight atmospheric pressure, freight vibration, freight shock, freight ambient light, and door status. In some embodiments, the method further comprises the step of generating, by the computer, a graph or chart describing telemetry information over time. In some embodiments, the portal displays telemetry information on a map. In further embodiments, the portal displays telemetry information on a map in the form of a breadcrumb trail. In still further embodiments, each breadcrumb comprises telemetry information. In some embodiments, the biometric information comprises at least one fingerprint. In some embodiments, the users associated with an order include at least one of: a shipper, a carrier, a broker, an operator, a receiver, and an insurer. In some embodiments, the method further comprises the step of monitoring, by the computer, freight integrity information from an array of sensors attached to, associated with, or operably connected to freight transport equipment. In some embodiments, the sensors communicate with a sensor hub. In further embodiments, the sensors and hub form a hub and spoke network. In some embodiments, the method further comprises the step of scoring at least one of: carriers, operators, brokers, shippers, and receivers. In further embodiments, the scoring is reported, at the portal, as a report card comprising at least one of: pick-up exceptions, drop-off exceptions, arrival exceptions, freight integrity exceptions, shipper reviews, and receiver reviews.

In another aspect, disclosed herein is a computer-implemented system comprising: (a) a digital processing device comprising an operating system configured to perform executable instructions and a memory device; (b) a sensor coupled to the digital processing device; and (c) a computer program including instructions executable by the digital processing device to create an application comprising: (i) a software module configured to receive or transmit data stored in a database of freight carriers, freight transport equipment and/or operators; (ii) a software module configured to receive or transmit data stored in a database of freight transport orders, provided that each order comprises an associated carrier; (iii) a software module configured to receive or transmit data generated by the sensor. In some embodiments, the system comprises a server. In some embodiments, the server comprises the database of freight carriers, freight transport equipment or operators. In some embodiments, the server comprises the database of freight transport orders. In some embodiments, the server is coupled to the digital processing device. In some embodiments, the server is coupled to the sensor. In some embodiments, the server transmits data stored in the database of freight carriers, freight transport equipment and/or operators to the digital processing device. In some embodiments, the server transmits data stored in a database of freight transport orders to the digital processing device. In some embodiments, the digital processing device comprises a server or is a server. In some embodiments, the digital processing device comprises a mobile device or is a mobile device. In some embodiments, the digital processing device comprises a cell phone or is a cell phone. In some embodiments, the digital processing device comprises a portable computer or is a portable computer. In some embodiments, the digital processing device comprises a communication interface. In some embodiments, the communication interface is for cellular network access. In some embodiments, the communication interface is for wireless network access. In some embodiments, the digital processing device comprises a biometric identifier. In some embodiments, the biometric identifier comprises a fingerprint recognition system. In some embodiments, the biometric identifier comprises an iris recognition system. In some embodiments, the biometric identifier comprises a face recognition system. In some embodiments, the sensor comprises a chip, a tag, a tracking tag, an RF tag, a gyrosensor, a data storage, or a combination thereof. In some embodiments, the data storage is shared or accessed by two or more sensors. In some embodiments, the sensor comprises a communication interface coupled to the digital processing device. In some embodiments, the communication interface comprises a wired communication interface controller. In some embodiments, the communication interface comprises a wireless communication interface controller. In some embodiments, the coupling is used for data transfer between the sensor and the digital processing device. In some embodiments, the coupling is a wired connection. In some embodiments, the coupling is a wireless connection. In some embodiments, the wireless connection is between the sensor and a wireless network interface controller of the digital processing device. In some embodiments, the sensor is attached to, associated with, or operably connected to freight transport equipment. In some embodiments, the sensor updates a status of freight transport equipment periodically or in real-time. In some embodiments, the status of freight transport equipment comprises one or more of: available, booked, dispatched, arrived at pick up, loaded, arrived at drop off, drop, and/or empty. In some embodiments, a freight carrier is identified by an operating authority or a USDOT number. In some embodiments, a freight carrier is identified by an identification number. In some embodiments, the identification number comprises a vehicle identification number. In some embodiments, the application is a software as a service. In some embodiments, the application is a software application available for download in an online application store. In some embodiments, the application further comprises a software module configured to update the database of freight carriers, freight transport equipment and/or operators. In still further embodiments, the application further comprises a software module configured to update the database of freight transport. In some embodiments, the application further comprises a software module configured to update data storage of one or more sensors. In some embodiments, an order further comprises an associated freight transport equipment and operator. In some embodiments, freight transport equipment comprises at least one of: tractor, trailer, shipping container, rail car, aircraft, and/or watercraft. In some embodiments, an operator is identified by at least one of: name, license state, license number, operating history, and/or biometric information. In some embodiments, the biometric information comprises at least one fingerprint. In some embodiments, the freight transport equipment information comprises telemetry information. In some embodiments, the telemetry information comprises at least one of: location, speed, direction, altitude, freight temperature, freight humidity, freight atmospheric pressure, freight vibration, freight shock, freight ambient light, and/or door status. In some embodiments, the application further comprises a software module for graphing or charting telemetry information over a period of time.

In another aspect, disclosed here in is a non-transitory computer readable storage media encoded with a computer program including instructions executable by a processor to create a software application comprising: (a) a software module configured to read data generated by a sensor attached to, associated with, or operably connected to a freight transport equipment; (b) a software module configured to read data stored in a database of freight carriers, freight transport equipment and/or operators; and (c) a software module configured to read data stored in a database of freight transport orders, provided that each order comprises an associated carrier. In some embodiments, the software application further comprises a software module configured to configure the database of freight carriers, freight transport equipment and/or operators. In some embodiments, the software application further comprises a software module configured to configure the database of freight transport orders. In some embodiments, the software application further comprises a software module configured to identify a biometric feature of a user. In some embodiments, the biometric feature comprises a fingerprint, a palm print, an iris, a face, or any combination of thereof. In some embodiments, the software application further comprises a software module configured to configure the sensor. In some embodiments, the sensor comprises a chip. In some embodiments, the sensor comprises a tag, a tracking tag, an RF tag, a gyrosensor, a data storage, or any combination thereof. In some embodiments, the data storage is shared or accessed by two or more sensors. In some embodiments, the sensor comprises a communication interface coupled to a digital processing device where the media is installed. In some embodiments, the software application further comprises a software module configured to update a status of the freight transport equipment periodically or in real-time. In some embodiments, the status of freight transport equipment comprises one or more of: available, booked, dispatched, arrived at pick up, loaded, arrived at drop off, drop, empty, or any combination thereof.

In some embodiments, a freight carrier is identified by an operating authority or by a USDOT number. In some embodiments, a freight carrier is identified by an identification number. In some embodiments, the identification number comprises a vehicle identification number. In some embodiments, the software application is software as a service. In some embodiments, the software application is available in an online application store. In some embodiments, the software application further comprises a software module configured to update the database of freight carriers, freight transport equipment and/or operators. In some embodiments, the software application further comprises a software module configured to update the database of freight transport. In some embodiments, the application further comprises a software module configured to update data storage of one or more sensors. In some embodiments, an order further comprises an associated freight transport equipment and/or an operator. In some embodiments, freight transport equipment comprises at least one of: tractor, trailer, shipping container, rail car, aircraft, watercraft, or any combination thereof. In some embodiments, an operator is identified by at least one of: name, license state, license number, operating history, biometric information, and any combination thereof. In some embodiments, the biometric information comprises at least one fingerprint. In some embodiments, the freight transport equipment information comprises telemetry information. In some embodiments, the telemetry information comprises at least one of: location, speed, direction, altitude, freight temperature, freight humidity, freight atmospheric pressure, freight vibration, freight shock, freight ambient light, door status, and any combination thereof. In some embodiments, the application further comprises a software module for graphing or charting telemetry information over a period of time.

In another aspect, disclosed herein is a non-transitory computer readable storage media encoded with a computer program including instructions executable by a processor to create a software application comprising: (a) a software module configured to receive freight transport equipment information associated with an order; and (b) a software module configured to generate a shared portal that displays information associated with the orders including the carrier, the equipment, the operator, and/or the biometric information, wherein the portal is accessible by all users associated with an order. In some embodiments, the software application further comprises a software module configured to read a database of freight carriers, freight transport equipment, or operators. In some embodiments, the software application further comprises a software module configured to read a database of freight transport orders, provided that each order comprises an associated carrier.

In another aspect, disclosed herein is a computer-implemented method comprising: (a) receiving data stored in a database of freight carriers, freight transport equipment and/or operators; (b) receiving data stored in a database of freight transport orders, provided that each order comprises an associated carrier; and (c) receiving data generated by a sensor. In some embodiments, the digital processing device comprises a communication interface. In some embodiments, the communication interface is for cellular network access. In some embodiments, the communication interface is for wireless network access. In some embodiments, the digital processing device is a mobile device. In some embodiments, the digital processing device is a cell phone. In some embodiments, the digital processing device is a portable computer. In some embodiments, the digital processing device comprises a biometric identifier. In some embodiments, the biometric identifier comprises a fingerprint recognition system. In some embodiments, the biometric identifier comprises an iris recognition system. In some embodiments, the biometric identifier comprises a face recognition system. In some embodiments, the method further comprises acquiring a biometric feature. In some embodiments, the biometric feature is a fingerprint, an iris, or a face, or a combination of thereof. In some embodiments, a sensor comprises a chip, a tag, a tracking tag, an RF tag, a gyrosensor, and/or a data storage, or any combination thereof. In some embodiments, the data storage is shared or accessed by two or more sensors. In some embodiments, the sensor comprises a communication interface coupled to the digital processing device. In some embodiments, the communication interface comprises a wired communication interface controller. In some embodiments, the communication interface comprises a wireless communication interface controller. In some embodiments, the coupling is used for data transfer between the sensor and the digital processing device. In some embodiments, the coupling is a wired connection. In some embodiments, the coupling is a wireless connection. In some embodiments, the wireless connection is between the sensor and a wireless network interface controller of the digital processing device. In some embodiments, the sensor is attached to, associated with, or operably connected to freight transport equipment. In some embodiments, the sensor updates a status of freight transport equipment periodically or in real-time. In some embodiments, the status of freight transport equipment comprises one or more of: available, booked, dispatched, arrived at pick up, loaded, arrived at drop off, drop, and/or empty.

In some embodiments, a freight carrier is identified by an operating authority or by a USDOT number. In some embodiments, a freight carrier is identified by an identification number. In some embodiments, the identification number comprises a vehicle identification number. In some embodiments, the method further comprises updating the database of freight carriers, freight transport equipment and/or operators. In some embodiments, the method further comprises updating the database of freight transport. In some embodiments, the method further comprises updating data storage of one or more sensors. In some embodiments, an order further comprises an associated freight transport equipment and/or an operator. In some embodiments, freight transport equipment comprises at least one of: tractor, trailer, shipping container, rail car, aircraft, and/or watercraft. In some embodiments, an operator is identified by at least one of: name, license state, license number, operating history, and/or biometric information. In some embodiments, the biometric information comprises at least one fingerprint. In some embodiments, the freight transport equipment information comprises telemetry information. In some embodiments, the telemetry information comprises at least one of: location, speed, direction, altitude, freight temperature, freight humidity, freight atmospheric pressure, freight vibration, freight shock, freight ambient light, and/or door status. In some embodiments, the method further comprises graphing or charting telemetry information over a period of time.

In another aspect, disclosed herein is a computer-implemented system for freight carrier verification comprising: (a) a database of freight carriers, freight transport equipment, and operators, wherein freight transport equipment information includes freight transport equipment location information, freight transport equipment status information and freight integrity information; (b) a database of freight transport orders, each order comprising an associated carrier; (c) a device attached to, associated with, or operably connected to freight transport equipment and configured to transmit freight transport equipment information; (d) a device attached to, associated with, or operably connected to freight transport equipment and configured to transmit operator biometric information; (e) a software module configured to verify: (1) operator integrity by matching biometric data collected at various points throughout transit against verified operator records and (2) equipment integrity through hardware attached to the transport equipment; (f) a software module configured to generate a shared portal that displays information associated with the orders including the carrier, the equipment, the operator, and the biometric information, wherein the portal is accessible by all users associated with an order; (g) a software module configured to define a geofence associated with at least one of: a freight pick-up location, a way point, and a freight drop-off location, wherein the geofence is utilized to automatically update the status of freight transport equipment; (h) a software module for scoring individuals or entities including carriers, operators, brokers, shippers, receivers, and the like based on the tracking of the carry-out of freight transport orders; (i) a software module for creating and displaying scorings and reviews on individuals and entities in a shared portal, wherein scorings and reviews are accessible to all users for choosing of entities for future orders. In some embodiments, the operator integrity is verified by collecting biometric data every 1, 10, 15, 30, 45, or 60 minutes, including increments therein. In some embodiments, the operator integrity is verified by collecting data every 2, 4, 6, 8, 10, 12, 16, or 24 hours, including increments therein. In some embodiments, the operator integrity is verified by collecting biometric data every 2, 4, 6, 8, 10, 12, 14, 16, 20, or 24 days, including increments therein. In some embodiments, the operator integrity is verified by collecting biometric data every 1, 2, 4, 6, 8, 10, 20, 30, 40, 50 75, 100, 200, 300, 400, 500, 750, or 1,000 miles, including increments therein. In some embodiments,

### BRIEF DESCRIPTION OF THE DRAWINGS

FIG. 1 shows a non-limiting exemplary schematic diagram of a system for freight carrier verification; in this case, a system including data tracking components and data reporting components connected by and monitored by an alarm manager.

FIG. 2 shows non-limiting exemplary schematic diagrams illustrating devices that are configured to transmit freight transport equipment information.

FIG. 3 shows a non-limiting exemplary schematic diagram of a device configured to transmit freight transport equipment information; in this case, a device including a GPS module, a GSM module, an accelerometer module, and input/output for a plurality of sensors.

FIG. 4 shows a non-limiting example of a home page for a shared portal; in this case, a home page offering creation of a new account.

FIG. 5 shows a non-limiting exemplary view of a shared portal for a freight carrier verification system; in this case, a shared portal including a console for tracking orders and associated carrier, equipment, and operator information.

FIG. 6 shows a non-limiting exemplary view of a shared portal for a freight carrier verification system; in this case, a shared portal including an order detail summary.

FIG. 7 shows a non-limiting exemplary view of a shared portal for a freight carrier verification system; in this case, a shared portal including telemetry data displayed on a map as a breadcrumb trail for one order.

FIG. 8 shows a non-limiting exemplary view of a shared portal for a freight carrier verification system; in this case, a shared portal including telemetry data graphed and correlated over time.

FIG. 9 shows a non-limiting exemplary view of a shared portal for a freight carrier verification system; in this case, a shared portal including an order check-call tracking summary.

FIG. 10 shows a non-limiting exemplary view of a shared portal for a freight carrier verification system; in this case, a shared portal including a feature to enter new order information.

FIG. 11 shows a non-limiting exemplary view of a shared portal for a freight carrier verification system; in this case, a shared portal including a feature to enter pickup and delivery information for a new order.

FIG. 12 shows a non-limiting exemplary view of a shared portal for a freight carrier verification system; in this case, a shared portal including a feature to enter accounts receivable and accounts payable information for a new order.

FIG. 13 shows a non-limiting exemplary view of a shared portal for a freight carrier verification system; in this case, a shared portal including a feature to enter carrier and equipment information for a new order.

FIG. 14 shows a non-limiting exemplary view of a shared portal for a freight carrier verification system; in this case, a shared portal including a feature to set alarms for a new order.

FIG. 15 shows a non-limiting exemplary view of a shared portal for a freight carrier verification system; in this case, a shared portal including a feature to enter load sharing information for a new order.

FIG. 16 shows a non-limiting exemplary view of a shared portal for a freight carrier verification system; in this case, a shared portal including a feature to enter and view other's comments for a new order.

FIG. 17 shows a non-limiting exemplary view of a shared portal for a freight carrier verification system; in this case, a shared portal including telemetry data displayed on a map as a breadcrumb trail for a plurality of orders.

FIG. 18 shows a non-limiting exemplary view of an administrative feature of a shared portal for a freight carrier verification system; in this case, an administrative feature of shared portal including tools to manage assets associated with an account.

FIG. 19 shows a non-limiting exemplary view of an administrative feature of a shared portal for a freight carrier verification system; in this case, an administrative feature of shared portal including tools to manage users associated with an account.

FIG. 20 shows a non-limiting exemplary view of an administrative feature of a shared portal for a freight carrier verification system; in this case, an administrative feature of shared portal including tools to manage contacts associated with an account.

FIG. 21 shows a non-limiting exemplary view of an administrative feature of a shared portal for a freight carrier verification system; in this case, an administrative feature of shared portal including tools to manage partnerships associated with an account.

FIG. 22 shows a non-limiting exemplary view of an administrative feature of a shared portal for a freight carrier verification system; in this case, an administrative feature of shared portal including tools to manage order alarm templates associated with an account.

FIG. 23 shows a non-limiting exemplary view of an administrative feature of a shared portal for a freight carrier verification system; in this case, an administrative feature of shared portal including tools to customize the portal by editing profile information associated with an account.

FIG. 24 shows a non-limiting exemplary view of an administrative feature of a shared portal for a freight carrier verification system; in this case, an administrative feature of shared portal including tools to customize the portal by editing commodity information associated with an account.

FIG. 25 shows a non-limiting exemplary view of an administrative feature of a shared portal for a freight carrier verification system; in this case, an administrative feature of shared portal including tools to customize the portal by editing equipment information associated with an account.

FIG. 26 shows a non-limiting exemplary view of an administrative feature of a shared portal for a freight carrier verification system; in this case, an administrative feature of shared portal including tools to customize the portal by editing billing information associated with an account.

FIG. 27 shows a non-limiting exemplary view of an administrative feature of a shared portal for a freight carrier verification system; in this case, an administrative feature of shared portal including tools to customize the portal by editing package type information associated with an account.

### DETAILED DESCRIPTION OF THE INVENTION

Advantages of the systems, devices, software, and methods described herein include, but are not limited to, a web-based or mobile portal application which provides an enhanced level of security and transparency for transactions between shippers, carriers, and receivers. Specifically, carriers are enabled to guarantee shippers and receivers that the agreed upon operator will operate the agreed upon equipment during transport. In this way, shippers and receivers are enabled to better manage and/or police their risk in transporting freight and carriers gain a competitive advantage in offering their customers a fully transparent and higher level of service.

Described herein, in certain embodiments, are computer-implemented systems for freight carrier verification comprising: a database of freight carriers, freight transport equipment, and operators; a database of freight transport orders, each order comprising an associated carrier; a device attached to, associated with, or operably connected to freight transport equipment and configured to transmit freight transport equipment information; a device attached to, associated with, or operably connected to freight transport equipment and configured to transmit operator biometric information; and a software module configured to generate a shared portal that displays information associated with the orders including the carrier, the equipment, the operator, and the biometric information, wherein the portal is accessible by all users associated with an order.

Also described herein, in certain embodiments, are computer readable storage media encoded with a computer program including instructions executable by a processor to create a freight carrier verification application comprising: a database of freight carriers, freight transport equipment, and operators; a database of freight transport orders, each order comprising an associated carrier; a software module configured to receive freight transport equipment information associated with an order; a software module configured to receive operator biometric information associated with an order; and a software module configured to generate a shared portal that displays information associated with the orders including the carrier, the equipment, the operator, and the biometric information, wherein the portal is accessible by all users associated with an order.

Also described herein, in certain embodiments, are computer-implemented methods comprising the steps of: maintaining a database of freight carriers, freight transport equipment, and operators in a computer memory; receiving, by a computer, an order for freight transport, wherein the order comprises a freight carrier; monitoring, by the computer, transmissions from a device attached to, associated with, or operably connected to freight transport equipment and configured to transmit freight transport equipment information; monitoring, by the computer, transmissions from a device attached to, associated with, or operably connected to freight transport equipment and configured to transmit operator biometric information; and generating, by the computer, a shared portal that displays information associated with the order including the carrier, the equipment, the operator, and the biometric information, wherein the portal is accessible by all users associated with an order.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Exemplary Overview

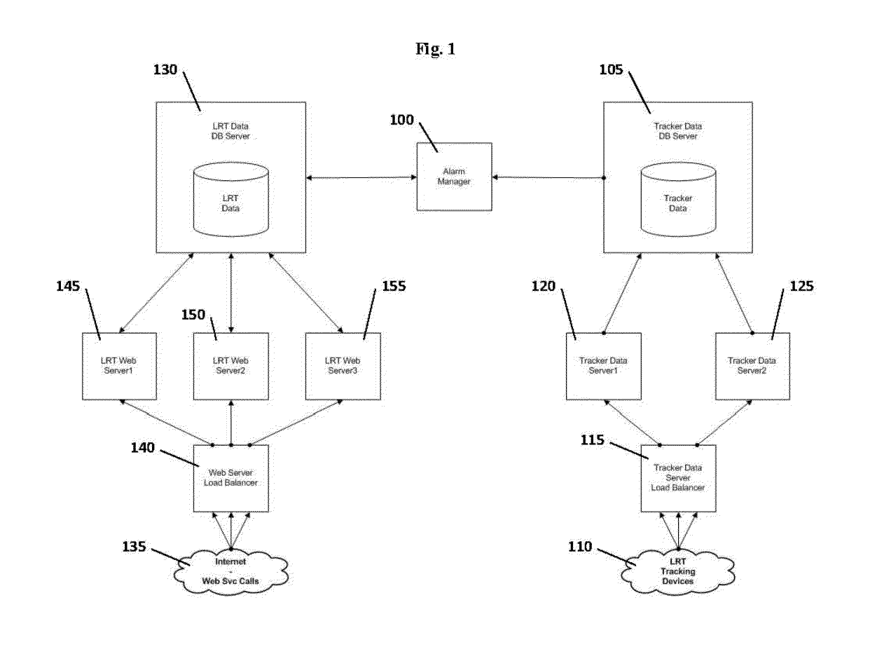

Referring to FIG. 1, in a particular embodiment, an alarm manager module 100 is in communication with both a tracker data database server 105 and a database server 130. In this embodiment, a tracker data database server 105 receives data from physical tracking devices attached to, associated with, or operably connected to freight transport equipment 110. Freight transport equipment information is routed through a tracker data server load balancer 115, to one of several tracker data servers 120, 125, and then to a tracker data database server 105 in communication with a tracker database. Further in this embodiment, a data database server 130 provides data via a web-based portal in response to requests made via the internet in the form of web service calls 135 (or by requests made by a user from a web browser). Web service calls and other internet traffic are routed through a web server load balancer 140, to one of several web servers 145, 150, 155, and then to a database server 130 in communication with a database.

### Freight Carriers

In some embodiments, the systems, devices, software, and methods described herein are for freight carrier verification. In further embodiments, as used herein, freight carrier means an entity ultimately responsible for a freight transport order. In still further embodiments, as used herein, freight carrier means an entity that coordinates and monitors freight, freight transport equipment, operators, billing, insurance, and other aspects of a freight transport order. A variety of entities are optionally freight carriers including, by way of non-limiting examples, regional, national, and international carriers, brokers, individuals, and the like. In some embodiments, a freight carrier owns freight transport equipment and employs full-time and/or part-time operators. In other embodiments, a freight carrier owns freight transport equipment and hires temporary and/or contract operators. In yet other embodiments, a freight carrier leases and/or temporarily contracts freight transport equipment and hires temporary and/or contract operators. In yet other embodiments, a freight carrier does not own freight transport equipment or hire operators. In further embodiments, a freight carrier is a broker of freight transport orders.

In some embodiments, a freight carrier is identified by an operating authority such as an authority to transport freight. In further embodiments, an authority to transport freight is granted by, for example, an international organization, a national government (or agency thereof), a state government (or agency thereof), a regional government (or agency thereof), a local government (or agency thereof), a not for profit organization, a non-governmental organization, or the like. In some embodiments, a freight carrier is identified by a U.S. Department of Transportation (USDOT) number.

In some embodiments, a freight carrier is identified by an operating authority such as a license to transport freight. In further embodiments, a license to transport freight is granted by, for example, an international organization, a national government (or agency thereof), a state government (or agency thereof), a regional government (or agency thereof), a local government (or agency thereof), a not for profit organization, a non-governmental organization, or the like. In some embodiments, a freight carrier is identified by an operating authority issued by the U.S. Federal Motor Carrier Safety Administration (FMCSA). In some embodiments, a freight carrier is identified by a Motor Carrier (MC) number.

In some embodiments, a freight carrier is identified by an insurance policy covering freight transport activities. In further embodiments, a freight carrier is identified by one or more insurance policy numbers and/or issuers.

In some embodiments, the systems, devices, software, and methods described herein include a database of freight carriers, or use of the same. In further embodiments, a database of freight carriers includes freight transport equipment, freight transport equipment operators, and the like, associated with one or more carriers. In still further embodiments, a database of freight carriers includes orders associated with one or more carriers.

In view of the disclosure provided herein, those of skill in the art will recognize that many databases are suitable for storage and retrieval of freight carriers (including associated freight transport equipment and operators) and freight transport orders. In various embodiments, suitable databases include, by way of non-limiting examples, relational databases, non-relational databases, object oriented databases, object databases, entity-relationship model databases, associative databases, and XML databases. In some embodiments, a database of freight carriers and freight transport orders in a computer memory is internet-based. In further embodiments, a database of freight carriers and freight transport orders in a computer memory is web-based. In still further embodiments, a database of freight carriers and freight transport orders in a computer memory is cloud computing-based. In other embodiments, a database of freight carriers and freight transport orders in a computer memory is based on one or more local computer storage devices.

In some embodiments, the systems, devices, software, and methods described herein further comprise a software module configured to administer the system, or use of the same. In further embodiments, a software module configured to administer the system allows addition, modification, and deletion of freight carrier information. In still further embodiments, a software module configured to administer the system allows association and disassociation of freight carrier information, freight transport equipment information, and/or operator information. In some embodiments, a software module configured to administer the system allows addition, modification, and deletion of freight transport order information. In further embodiments, a software module configured to administer the system allows association and disassociation of freight transport order information and freight carrier information, freight transport equipment information, and/or operator information.

### Freight Transport Equipment

In some embodiments, the systems, devices, software, and methods described herein include a database of freight transport equipment information, or use of the same. In some embodiments, the systems, devices, software, and methods described herein include a device attached to, associated with, or operably connected to freight transport equipment, or use of the same. In further embodiments, a device attached to, associated with, or operably connected to freight transport equipment is configured to transmit freight transport equipment information. In further embodiments, a device attached to, associated with, or operably connected to freight transport equipment is configured to transmit operator biometric information.

Many types of freight transport equipment are suitable. in various embodiments, suitable freight transport equipment includes, by way of non-limiting examples, automobiles, tractors, trailers, shipping containers, rail cars, aircraft, watercraft, and the like. In some embodiments, suitable freight transport equipment includes automobiles such as cars, trucks, tow trucks, vans, busses, etc. In some embodiments, suitable freight transport equipment includes tractors such as semi-tractors, semi-trailer trucks, transfer trucks, articulated vehicles, dump trucks, logging trucks, tank trucks, refrigerated trucks, road trains, auto transport trucks, etc. In some embodiments, suitable freight transport equipment includes trailers such as semi-trailers, box trailers, dry bulk trailers, refrigerated trailers, bus trailers, tank trailers, dump trailers, auto transport trailers, flatbed trailers, single trailers, multiple (e.g., double, triple, stacked, etc.), and the like. In some embodiments, suitable freight transport equipment includes shipping containers such as intermodal freight containers, boxes (including wooden boxes), corrugated boxes (including fiberboard boxes), crates, intermediate bulk shipping containers, intermediate bulk containers, flexible intermediate bulk containers, bulk boxes, drums (including steel drums), insulated shipping containers, etc. In some embodiments, suitable freight transport equipment includes rail cars such as auto racks, box cars, center beam cars, flat cars, well cars, gondolas, hoppers, lorries, open wagons, refrigerator cars, side dump cars, spine cars, stock cards, tank cars, Schnabel cars, etc. In some embodiments, suitable freight transport equipment includes aircraft such as propeller aircraft, jet aircraft, rotorcraft, gliders, blimps, balloons, etc. In some embodiments, suitable freight transport equipment includes watercraft such as airboat, barge, sailboat, cabin cruiser, cargo ship, catamaran, cruise ship, fishing boat, hovercraft, hydrofoil, hydroplane, ice boat, jet boat, pontoon boat, ferry, submarine, tanker, tug boat, etc. In some embodiments, manned and/or unmanned freight transport equipment is suitable.

### Freight Transport Equipment Information

In some embodiments, the systems, devices, software, and methods described herein include a database of freight transport equipment information, or use of the same. Many types of freight transport equipment information are suitable. In various embodiments, suitable freight transport equipment information includes, by way of non-limiting examples, freight transport equipment location information, freight transport equipment status information, freight integrity information, and the like.

In some embodiments, suitable freight transport equipment information includes location information. In further embodiments, location information includes telemetry information. In still further embodiments, telemetry information includes, by way of non-limiting examples, location (e.g., latitude/longitude, street address, distance to a landmark, position on a map, etc.), speed, direction (e.g., heading, etc.), and altitude. In still further embodiments, telemetry information is graphed and/or charted over time to illustrate, for example, location, speed, and/or altitude over the course of transport.

In some embodiments, suitable freight transport equipment information includes equipment status information. In further embodiments, freight transport equipment status information indicates whether freight is loaded or not. In further embodiments, freight transport equipment status information indicates whether freight transport equipment has departed or reached a particular location (e.g., a pickup, a drop off, a waypoint, etc.). In further embodiments, freight transport equipment status information indicates whether freight transport equipment is busy or available. In still further embodiments, freight transport equipment status information includes, by way of non-limiting examples, available, booked, dispatched, arrived at pick up, loaded, arrived at drop off, dropped, and empty.

In some embodiments, suitable freight transport equipment information includes freight integrity information. In further embodiments, freight integrity information indicates the conditions that freight is exposed to during transport. In still further embodiments, freight integrity information indicates whether freight is exposed to conditions beyond certain thresholds during transport. In still further embodiments, freight integrity information indicates whether freight is accessed, stolen, tampered with, or adulterated during transport. In some embodiments, freight integrity information includes, by way of non-limiting examples, temperature, humidity, atmospheric pressure, vibration, shock, and ambient light. In some embodiments, freight integrity information includes, door status (e.g., unopened, opened, opened a particular number of times, opened for a particular time period, etc.). In still further embodiments, freight integrity information is graphed and/or charted over time to illustrate, for example, temperature, humidity, atmospheric pressure, shock and/or vibration over the course of transport.

In view of the disclosure provided herein, those of skill in the art will recognize that many databases are suitable for storage and retrieval of freight transport equipment information, including any of the databases described herein.

In some embodiments, freight transport equipment information is collected and transmitted by a device attached to, integrated within, associated with, or operably connected to the freight transport equipment. In further embodiments, freight transport equipment information is collected and transmitted by an array of sensors in communication with a device attached to, integrated with, associated within, or operably connected to the freight transport equipment.

### System Design

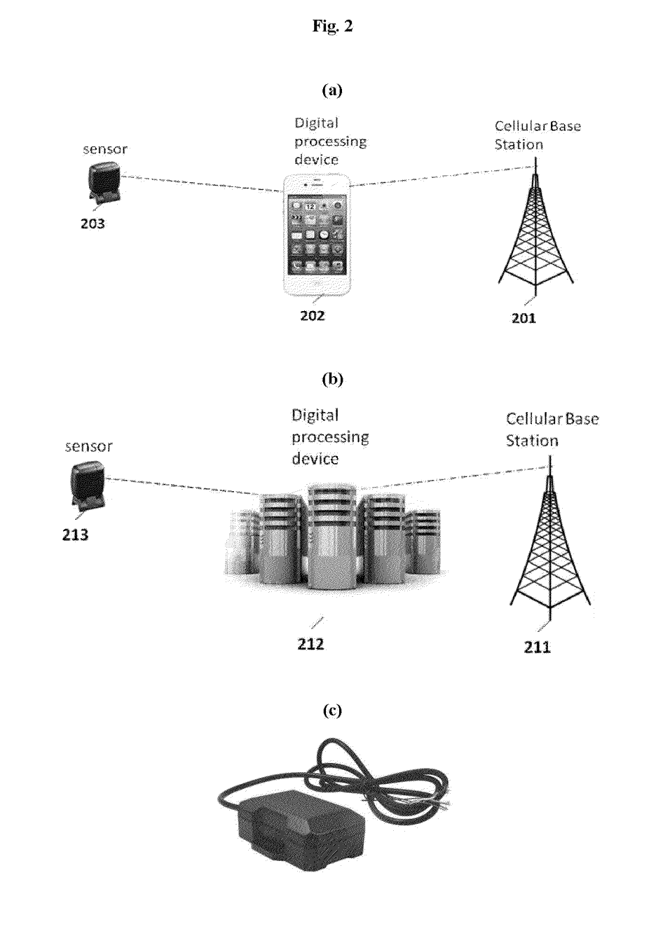

In some embodiments, the systems, devices, software, and methods described herein include a digital processing device. Suitable digital processing devices include a smartphone, a portable computing device, a desktop computer, a server, or any combination thereof. In some embodiments, the device comprises a communication interface. In some embodiments, the communication interface is for a network access. Suitable networks include by way of non-limiting example, cellular network access, satellite network access, wireless network access, wireless computer network access, local area network access, regional area network access, wide area network access, or any combination thereof. Referring to FIG. 2(a), which illustrates certain embodiments, including a digital processing device 202 which is a smartphone that is coupled to a sensor 203 via a network protocol and is configured to communicate to a cellular base station 201 via a cellular network protocol. In further or additional embodiments, the smartphone is coupled to a server; the smartphone and the server can transmit and receive data to/from each other. In some embodiments, a network connection described herein is realized by a wired connection or a wireless connection.

Alternatively, referring to FIG. 2(b) which illustrates certain embodiments of the subject matter provided herein, shown is a digital processing device 212 that comprises a server which is coupled to a sensor 213 via a network protocol. In further embodiments, the server 212 is configured to communicate to a cellular base station 211 via a cellular network protocol. In some embodiments, the digital processing device is a server which is coupled to a sensor only. In some embodiments, a network connection described herein is achieved by a wired connection or a wireless connection. FIG. 2(c) illustrates certain embodiments that provide a sensor and the digital processing device integrated into a single apparatus.

In some embodiments of the subject matter described herein, the systems, devices, software, and methods described herein comprise a device attached to, associated with, or operably connected to freight transport equipment and configured to transmit freight transport equipment information; a device attached to, associated with, or operably connected freight transport equipment and configured to transmit operator biometric information. Many mechanisms of attachment are suitable. In various embodiments, a device is attached to, associated with, or operably connected to freight transport equipment by, for example, fasteners, adhesives, welds, and the like. In some embodiments, a mechanism of attachment prevents tampering of the device or removal of the device from the freight transport equipment. In further embodiments, a device has a rugged, reinforced, or armored case and is attached to, associated with, or operably connected to freight transport equipment via a permanent, substantially permanent, or semi-permanent mechanism.

In some embodiments, the digital processing device comprises an identifier of biometric features. Non-limiting examples of biometric features include fingerprint, iris, palm, and/or face.

In some embodiments, the systems, devices, software, and methods described herein include a sensor. In some embodiments, the sensor comprises a chip, a tag, a tracking tag, an RF tag, and/or a gyro sensor, or any combination of the foregoing. In some embodiments, the sensor comprises a data storage. In further embodiments, the data storage is shared or accessed by two or more sensors. In some embodiments, the sensor comprises a communication interface coupled to the digital processing device. The communication interface comprises a wired communication interface controller and/or a wireless communication interface controller. The coupling between the sensor and the digital processing device is used for data transfer between the sensor and the digital processing device. In some embodiments, the coupling is a wired connection. Alternatively, the coupling is a wireless connection.

In some embodiments, the sensor is attached to, associated with, or operably connected to freight transport equipment. In some embodiments, the sensor collects freight equipment information. In some embodiments, the sensor updates a status of freight transport equipment periodically or real-time. Non-limiting examples of the status of freight transport equipment comprises one or more of: available, booked, dispatched, arrived at pick up, loaded, arrived at drop off, drop, and empty, or any combination thereof.

In some embodiments the systems, devices, software, and methods described herein include a software application. In some embodiments, the application is a software as a service. In some embodiments, the application is a software application available for download in an online application store.

In some embodiments of the subject matter provided herein, provided is a device attached to, associated with, or operably connected to freight transport equipment that is configured to transmit freight transport equipment information described further herein. In some embodiments, a device attached to, associated with, or operably connected to freight transport equipment and configured to transmit freight transport equipment information is a digital processing device comprising a processor. In some embodiments, a device attached to, associated with, or operably connected to freight transport equipment and configured to transmit freight transport equipment information includes a power source. In various embodiments, a suitable power source is a power line in from the freight transport equipment, a battery (e.g., zinc-carbon (ZnC), alkaline, nickel-cadmium (NiCd), nickel-zinc (NiZn), nickel metal hydride (NiMH), lithium-ion (Li-ion), etc.), or both. In some embodiments, a device attached to, associated with, or operably connected to freight transport equipment and configured to transmit freight transport equipment information includes a sensor input/output (I/O) element. In some embodiments, a device attached to, associated with, or operably connected to freight transport equipment includes a location component. In further embodiments a device includes a GPS element to access a positioning system. In some embodiments, a device attached to, associated with, or operably connected to freight transport equipment includes a communications component. In further embodiments a device includes a telecommunications element (e.g., GSM or similar) to communicate with a cellular phone network.

In some embodiments, a device attached to, associated with, or operably connected to freight transport equipment transmits freight transport equipment information, freight integrity information, and/or operator biometric information on a continuous or substantially continuous basis. In other embodiments, a device attached to, associated with, or operably connected to freight transport equipment transmits information on a periodic basis. Many transmission periods are suitable. In further embodiments, a device attached to, associated with, or operably connected to freight transport equipment stores information and transmits the information if and when a suitable communication channel becomes available. For example, a device utilizing a cellular radio to transmit information and attached to, associated with, or operably connected to an aircraft or to freight in an aircraft may not be able to transmit information during portions of the transport. In such cases, a device optionally stores freight transport equipment information, freight integrity information, and/or operator biometric information in a memory device and transmits the information if and when a cellular network signal becomes available.

Referring to FIG. 2(c), illustrated is a particular embodiment whereby a device is suitable for attachment to freight transport equipment and is configured to transmit freight transport equipment information. In this embodiment, the device includes a hard plastic case with features to facilitate attachment.

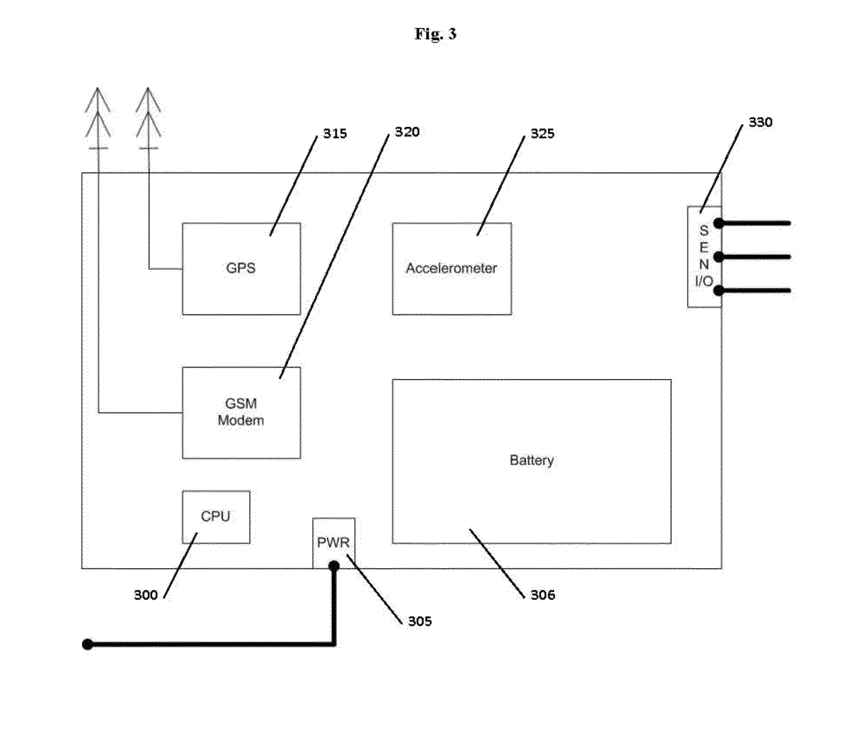

Referring to FIG. 3, in a particular embodiment, a device is suitable for attachment to freight transport equipment and is configured to transmit freight transport equipment information. In this embodiment, the device includes a central processing unit (CPU) 300 and both a line in 305 and a battery 306 to provide power. Further in this embodiment, the device includes a GPS module 315 with an antenna to access a positioning system and a GSM module 320, also with an antenna to communicate with a cellular phone network. The device in this embodiment further includes sensor elements such as an accelerometer module 325 and in input/output element 330 for a network of sensors.

A device is optionally attached to, associated with, or operably connected to freight transport equipment by a number of suitable parties. In some embodiments, a device is attached to, associated with, or operably connected to freight transport equipment by a shipper, a carrier, a broker, an operator, a receiver, or an equipment owner. In other embodiments, a device is attached to, associated with, or operably connected to freight transport equipment by a third party provider of the systems, devices, software, and methods described herein. In some embodiments, the quality and/or reliability of freight transport equipment information transmitted by a device is determined, at least in part, by the party attaching the device to freight transport equipment.

A device (attached to, associated with, or operably connected to freight transport equipment) is optionally inspected at one or more time points by a number of suitable parties. In various embodiments, a device is suitably inspected for, by way of non-limiting examples, integrity, attachment, tampering, and the like. In some embodiments, a device is inspected by a shipper, a carrier, a broker, an operator, a receiver, or an equipment owner. In other embodiments, a device is inspected by a third party provider of the systems, devices, software, and methods described herein. A device is suitably inspected at a variety of time points and/or time intervals. In some embodiments, a device is inspected at one or more key points in freight transport, including, by way of non-limiting examples, pickup, a way point, drop off, and the like. In some embodiments, a device is inspected periodically. In various further embodiments, a device is inspected yearly, semi-yearly, quarterly, month, semi-monthly, weekly, daily, and hourly, including increments therein. In some embodiments, the quality and/or reliability of freight transport equipment information transmitted by a device is determined, at least in part, by the party inspecting the device, the time point(s) of inspection, and/or the time interval between inspections.

In some embodiments, a device configured to transmit freight transport equipment information comprises a cellular interface, non-cellular interface, or both of cellular and non-cellular interfaces. Suitable wireless devices are, by way of non-limiting examples, mobile phones, mobile computing devices, smartphones, portable computers, tablet computers, mobile computers, hot spots, routers, gateways, switches, cameras, audio recorders, video recorders, music players, video players, portable electronic devices, and wearable electronic devices. Alternatively, the wireless devices may be non-portable devices containing cellular interfaces and/or non-cellular interfaces.

In some embodiments, an interface in a device comprises a hardware module, implemented by an electronic circuitry, to generate and receive an electromagnetic wave. In certain applications, the implementation of the interface belongs to part of an electronic circuitry. By way of a non-limiting example, the electromagnetic wave may be a radiofrequency wave, a light beam, or an infrared wave. In further embodiments, the interface includes an electronic circuitry for controlling the electromagnetic waveform modulation, demodulation, encoding, decoding, generation, and/or receiving. The controlling mechanisms may be implemented by a hardware module, by a software module, or by a combination of hardware and software modules.

In some embodiments, a device with a cellular interface and/or a non-cellular interface is coupled with one or more Radio-frequency identification (RFID) chips or tags. In further embodiments, the coupling between the device and RFID chips/tags is wireless or wired; when wireless coupling coupling is embodied, the coupling is made through cellular communication, non-cellular communication, or a combination of thereof. In certain embodiments, one or more RFID chips/tags are attached to the device, freight transport equipment, an operator, items/packages, and/or a component of a vehicle. In some embodiments where there are two or more RFID chips or tags, two or more of them are identical, or all of them are distinct. In additional embodiments, the RFID chips or tags are corresponding to the identification of the device, freight transport equipment, operators, items/packages, and/or vehicle components.

### Operator Information

In some embodiments, the systems, devices, software, and methods described herein include a database of freight transport equipment operator information, or use of the same. In further embodiments, operator information identifies an operator associated with a freight transport order. In still further embodiments, operator information identifies an operator operating freight transport equipment specified in an order. In still further embodiments, operator information identifies an operator participating in transport of freight specified in an order.

Many types of operator information are suitable. In some embodiments, suitable operator information identifies an operator. In some embodiments, suitable operator information indicates an operator's professional record, professional performance, licensures, and the like. In various embodiments, suitable operator information includes, by way of non-limiting examples, name, age, date of birth, address, phone number, social security number, state issuing driver's license, driver's license number, operating history, biometric information, and the like.

Many types of operating histories are suitable. In various embodiments, operating histories includes, by way of non-limiting examples, driving records, professional performance reviews, professional discipline records, criminal records, insurance records, and the like.

Many types of biometric information are suitable. In various embodiments, suitable biometric information includes, by way of non-limiting examples, photographic information, retinal information, iris information, fingerprint information, palm print information, facial geometry information, voice information, and combinations thereof. In further various embodiments, photographic information includes one or more still or motion images of, for example, an operator's face, head and shoulders, or full body.

In some aspects, disclosed herein is a software module configured to verify operator integrity by matching biometric data collected at various points throughout transit against verified operator records; and equipment integrity through hardware attached to the transport equipment. In some embodiments, the operator integrity is verified by collecting biometric data every 1, 10, 15, 30, 45, or 60 minutes, including increments therein. In some embodiments, the operator integrity is verified by collecting data every 2, 4, 6, 8, 10, 12, 16, or 24 hours, including increments therein. In some embodiments, the operator integrity is verified by collecting biometric data every 2, 4, 6, 8, 10, 12, 14, 16, 20, or 24 days, including increments therein. In some embodiments, the operator integrity is verified by collecting biometric data every 1, 2, 4, 6, 8, 10, 20, 30, 40, 50 75, 100, 200, 300, 400, 500, 750, or 1,000 miles, including increments therein. In some embodiments, the operator integrity is verified by collecting biometric data at intervals based upon the percentage of trip completed, such as when the trip is 1, 2, 4, 6, 10, 25, 50, 75, 90, 95, or 99 percent completed, including increments therein.

In view of the disclosure provided herein, those of skill in the art will recognize that many databases are suitable for storage and retrieval of operator information, including any of the databases described herein.

In some embodiments, the systems, devices, software, and methods described herein include a device attached to, associated with, or operably connected to freight transport equipment, or use of the same. In further embodiments, a device attached to, associated with, or operably connected to freight transport equipment is configured to transmit operator biometric information described herein. In some embodiments, a device attached to, associated with, or operably connected to freight transport equipment and configured to transmit operator biometric information is attached to, associated with, or operably connected to freight transport equipment in a location that is accessible by an operator. In further embodiments, such a device is accessible by an operator while operating the equipment. In some embodiments, a device attached to, associated with, or operably connected to freight transport equipment and configured to transmit operator biometric information includes an input component to read or capture operator biometric information. In further embodiments, an input component includes, by way of non-limiting examples, a still camera, a video camera, a fingerprint reader, a palm print reader, a retina scanner, an iris scanner, and the like.

In some embodiments, an input component includes a camera to capture photographic information, facial geometry information, or combinations thereof. In further embodiments, a camera is a digital camera. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and higher megapixel cameras, including increments therein. In some embodiments, a digital camera is a standard definition camera. In other embodiments, a digital camera is an HD video camera. In further embodiments, an HD video camera captures images with at least about 1280× about 720 pixels or at least about 1920× about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia. In further embodiments, a camera is a high-definition camera. In some embodiments, an input component includes a microphone to capture voice information.

### Sensors and Sensor Networks

In some embodiments, the systems, devices, software, and methods described herein include at least one sensor, or use of the same. In further embodiments, the systems, devices, software, and methods described herein include a plurality of sensors configured into a sensor array, or use of the same. An array of sensors suitably includes a wide range of number of individual sensors. In various embodiments, an array of sensors includes 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100 or more sensors, including increments therein.

In some embodiments, a sensor comprises a power source, an environmental sensing module, and a communications module. Both wired and wireless sensors are suitable. In some embodiments, the sensors are wired sensors. In other embodiments, the sensors are wireless sensors. In yet other embodiments, the sensors are a combination of wired and wireless sensors. In some embodiments, a wireless sensor further comprises a radio transceiver and an internal or external antenna. Many communications protocol are suitable for wireless sensors including, by way of non-limiting examples, 802.11x, Wi-Fi, ZigBee, Bluetooth, Bluetooth LE, and ANT.

In some embodiments, sensors are utilized to capture freight integrity information and are associated with freight transport equipment. For example, in some embodiments, one or more sensors are associated with a semi-trailer, a railcar, the cargo hold of a watercraft, and the like. In further embodiments, one or more sensors are associated with each cargo shipping container, crate, drum, or box associated with a freight transport order. Sensors are suitably utilized to capture a wide variety of type of environmental information associated with freight integrity. In various embodiments, environmental information associated with freight integrity suitably captured by sensors includes, by way of non-limiting examples, light, temperature, humidity, shock, vibration, sound, atmospheric pressure, location, altitude, and the like.

In some embodiments, a plurality of sensors form a sensor network. Many sensor network topologies are suitable. In various embodiments, suitable sensor network topologies include, by way of non-limiting examples, line, ring, star, tree, mesh, fully-connected, bus configurations, and the like. In some embodiments, one more sensors communicate with a sensor hub to form a network. In various embodiments, suitable hub and sensor network topologies include, by way of non-limiting examples, star network, hub and spoke network, multi-hop wireless mesh network, and the like. In a particular embodiment, a plurality of sensors and a hub are configured in a hub and spoke network.

### Geofencing

In some embodiments, the systems, devices, software, and methods described herein include a software module for defining a geofence, or use of the same. As used herein, in some embodiments, a geofence is a virtual perimeter for a real-world geographic area. Many types of geofences are suitable for configuration with the systems, devices, software, and methods described herein. In various embodiments, geofences suitably define, for example, a pick-up location, a way point location, a device inspection location, a drop-off location, or the like.

A geofence suitably has any shape. In various embodiments, suitable geofence shapes include, by way of non-limiting examples, a circle (defined by a radius about a point), a square, a rectangle, a triangle, a polyhedron, an irregular shape, and the like. A geofence suitably has any size. In various embodiments, suitable geofence sizes include, by way of non-limiting examples, 50, 45, 40, 35, 30, 25, 20, 15, 10, 9, 8, 7, 6, 5, 4, 3, 2, 1 or less square kilometers, including increments therein. In various further embodiments, suitable geofence sizes include, by way of non-limiting examples, 1000, 900, 800, 700, 600, 500, 400, 300, 200, 100, 50, 45, 40, 35, 30, 25, 20, 15, 10 or less square meters, including increments therein.

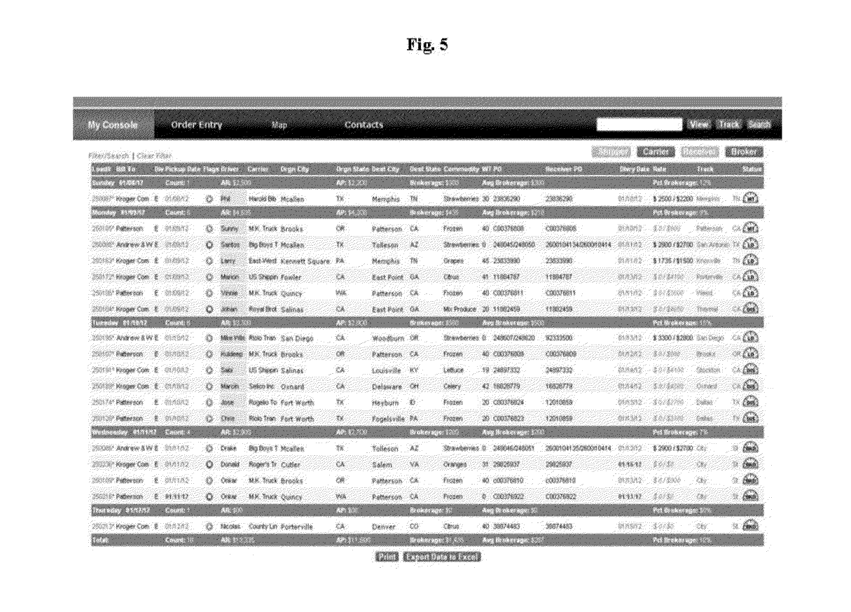

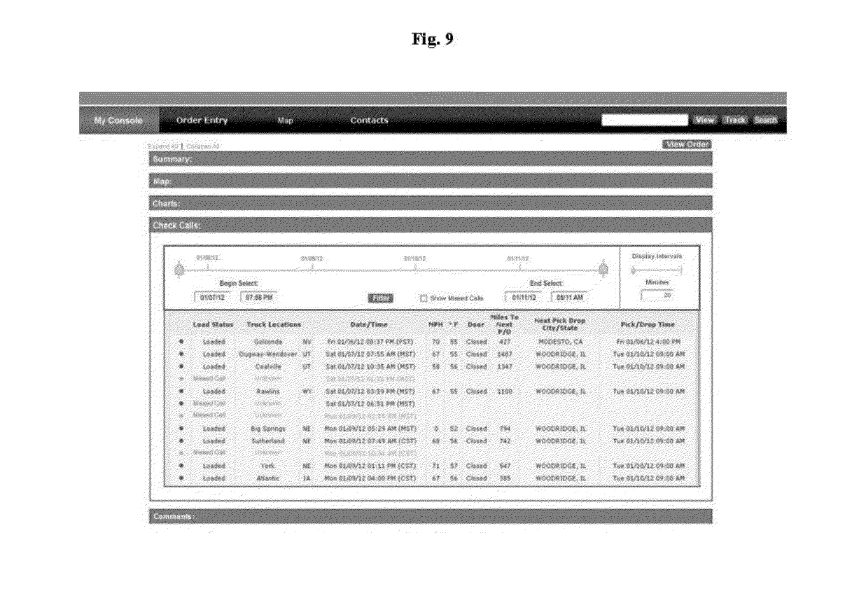

In some embodiments, a geofence is used to update the status of, for example, an order, freight transport equipment, an operator, or the like, in a shared portal. In a particular embodiment, one or more geofences are utilized to automatically update the status of freight transport equipment in a shared portal. See, e.g., FIGS. 5 and 9. For example, a carrier may configure a geofence of 10 square kilometers around the drop off location for a particular order. By way of further example, the status of the transport equipment is changed to “arrived at drop off” when the equipment enters the geofenced area. Many location based equipment statuses are suitable based on a geofence including, by way of non-limiting examples, available, booked, dispatched, arrived at pick up, loaded, arrived at drop off, drop, and empty. In some embodiments, a score is associated with the carry out of freight orders. In further embodiments, a score is associated with the tracking of freight carriers, freight transport equipment, and operators for a freight order. In further embodiments, a score is associated with the tracking of freight transport equipment location information, freight transport equipment status information and freight integrity information during a freight order. In some embodiments, a score is associated with the verification of operator integrity and freight integrity.

In some embodiments, a geofence is used to trigger an alert or notification based on the location of freight transport equipment, the status of freight transport equipment, or the status of an order. In some embodiments, an alert or notification is provided via a shared portal described herein. In other embodiments, an alert or notification is provided via email, SMS, MMS, automated phone call, microblog entry, post to a social media application, site, or serves, and the like. Any of the stake holders described herein are suitable recipients for alerts and/or notifications. In some embodiments, alerts and notifications enhance the visibility and transparency of order status, freight transport equipment information, operator information, and the like.

In some embodiments, a shared portal described herein suitably displays scores and reviews for individuals or entities. In some embodiments, scores and reviews in a shared portal are accessible to all users. In some embodiments, rankings of scores and reviews are displayed in a shared portal. In some embodiments, comparisons of scores and reviews of different individuals or entities are accessible in a shared portal. In some embodiments, scores and reviews for individuals or entities are accessed by users to choose future individuals or carriers.

### Scoring

In some embodiments, the systems, devices, software, and methods described herein include a software module for scoring individuals or entities, or use of the same. In further embodiments, a software module for scoring individuals or entities scores carriers, operators, brokers, shippers, receivers, and the like. Many formats are suitable for a score. In some embodiments, a score is displayed as a numeric score, such as a number on a numeric scale. In other embodiments, a score is displayed as a letter score, such as a letter score on an alphabetic scale. In yet other embodiments, a score is displayed as a report card comprising scores in one or more categories. In further embodiments, a report card comprises scores in categories including, by way of non-limiting examples, pick-up exceptions, drop-off exceptions, arrival exceptions, freight integrity exceptions, and the like.

In some embodiments, a software module for scoring individuals or entities provides a system to create and browse reviews. In further embodiments, a shipper creates reviews. In further embodiments, a receiver creates reviews. In still further embodiments, a shipper and/or a receiver reviews a carrier, an operator, a broker, an equipment owner, an insurer, or the like.

### Shared Portal

In some embodiments, the systems, devices, software, and methods described herein include a software module configured to generate a shared portal, or use of the same. In some embodiments, a shared portal is intranet-based. In some embodiments, a shared portal is internet-based. In further embodiments, a shared portal is web-based. In still further embodiments, a shared portal is cloud computing based. In some embodiments, a shared portal is implemented as a web application and offered as software-as-a-service. In other embodiments, a shared portal is implemented as a mobile application offered for purchase and download. In yet other embodiments, a shared portal is implemented as a free mobile application available download.

A shared portal described herein suitably displays a wide range of information. In some embodiments, a shared portal described herein suitably displays information associated with freight transport orders including, by way of non-limiting examples, the carrier, the shipper, the receiver, the pickup location, the destination, the equipment, the location of the equipment, party installing device on equipment, the status of the equipment, telemetry information, projected arrival date and time, the operator, the operator's biometric information, way points and/or inspection points, date of last device inspection (including party making inspection), freight integrity information, and the like. In some embodiments, a shared portal described herein displays orders with which the user is involved. In further embodiments, the orders are partial orders, such as a posting of available freight that needs transport or an available piece of freight transport equipment that does not currently have a load or will soon be empty. In other embodiments, the orders are consummated orders, wherein available freight is paired with freight transport equipment. In some embodiments, a shared portal described herein optionally displays both partial and consummated orders and is filterable, searchable, and sortable.

The information displayed by a shared portal described herein is updated at a wide range of suitable time intervals. In various embodiments, the information displayed by a shared portal described herein is updated, for example, at least every 12, 11, 10, 9, 8, 7, 6, 5, 4, 3, 2, 1, or less hours, including increments therein. In various further embodiments, the information displayed by a shared portal described herein is updated, for example, at least every 60, 55, 50, 45, 40, 35, 30, 25, 20, 15, 14, 13, 12, 11, 10, 9, 8, 7, 6, 5, 4, 3, 2, 1 or less minutes, including increments therein. In various further embodiments, the information displayed by a shared portal described herein is updated, for example, at least every 60, 55, 50, 45, 40, 35, 30, 25, 20, 15, 14, 13, 12, 11, 10, 9, 8, 7, 6, 5, 4, 3, 2, 1 or less seconds, including increments therein. In some embodiments, the information is updated continuously or substantially continuously such that the information is provided in real-time or substantially in real-time.

In some embodiments, a shared portal described herein is accessible to all stakeholders for a freight transport order. In further embodiments, a shared portal described herein is accessible to, by way of non-limiting examples, shippers, carriers, brokers, equipment operators, receivers, equipment owners, freight owners, and insurers. Many means of access are suitable including, by way of non-limiting examples, credentials to log into a portal, secure/private URL, and the like. In some embodiments, access is unlimited. In other embodiments, access is based on the role and/or involvement of the user. For example, in further embodiments, a user has access only to information pertaining to orders with which they are involved. By way of further example, an operator's access may include only access to information pertaining to orders for which they operate freight transport equipment. In some embodiments, access by all stakeholders for a freight transport order creates transparency to the information pertaining to the order such as, the equipment in use to transport the freight, the party installing the device on the equipment, the operator of the equipment, the identity or biometric information of the operator of the equipment, the status and location of the equipment, projected arrival date and time, the last inspection date of the device, the party making the last inspection of the device, the integrity of the freight, the insurer of the freight, and the operating authority that the freight is transported under. In further embodiments, transparency of such information is a means of freight carrier verification.

In some embodiments, particular information or types of information are private and viewable only by the owner of the information or the party entering the information. In other embodiments, particular information or types of information are semi-private and viewable only by one or more authorized parties. In further embodiments, alarms (e.g., alarm templates or alarms configured for a particular order) are private or semi-private information. In further embodiments, financial information is private or semi-private information. In further embodiments, one or more comments are private or semi-private information. In some embodiments, particular information or types of information are viewable only by the owner of the information, the party entering the information, and their partners established in the system. In further embodiments, particular information or types of information are initially viewable by a group, such as the owner of the information and their partners, and subsequently viewable after a delay period by a larger group or by all users.

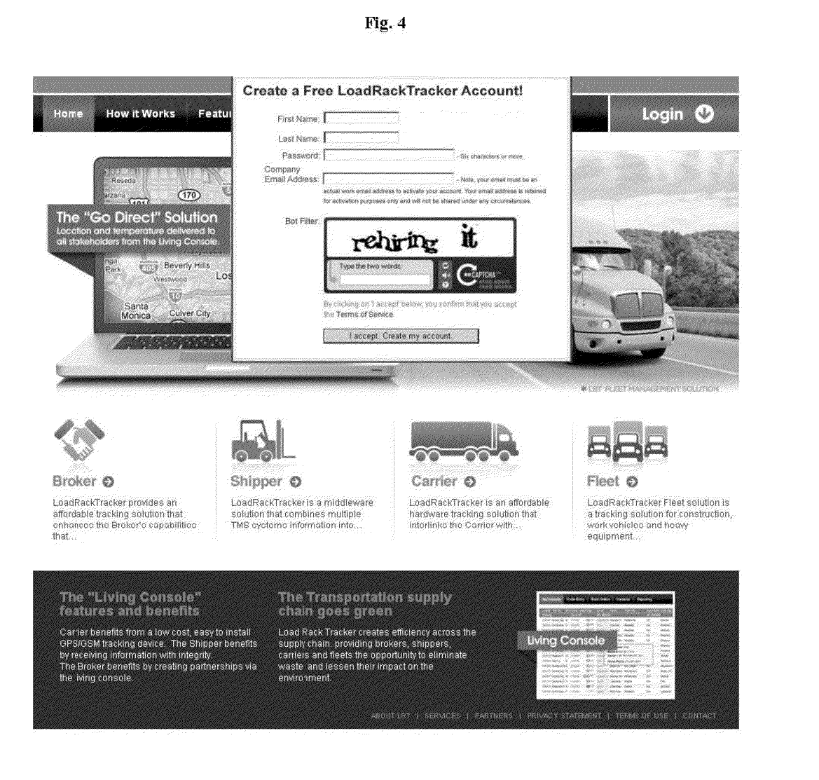

Referring to FIG. 4, in a particular embodiment, a shared portal is implemented as a web application and offered as software-as-a-service. In this embodiment, a shared portal includes a graphical user interface (GUI) allowing users to create a new account within the application. Further in this embodiment, when a new user creates an account they are issued an individual user ID, which is optionally associated with an organization (e.g., company, business, etc.) user ID. In some embodiments, an organization user ID is optionally associated with a plurality of individual users IDs (e.g., employees, contractors, etc.), which are further optionally configured into groups within the organization.

Referring to FIG. 5, in a particular embodiment, a shared portal includes a user console. In this embodiment, a console includes a list of freight transport orders with which the user is involved. Further in this embodiment, for each order, a console displays the party responsible for receiving billing statements for the order, a driver, a carrier, a destination state, a destination city, a description of the freight, a weight for the freight, a shipper PO, a receiver PO, a current location of the freight transport equipment, and a current freight transport equipment status. In this embodiment, the console is searchable, sortable, and is optionally filtered to refine the displayed information.

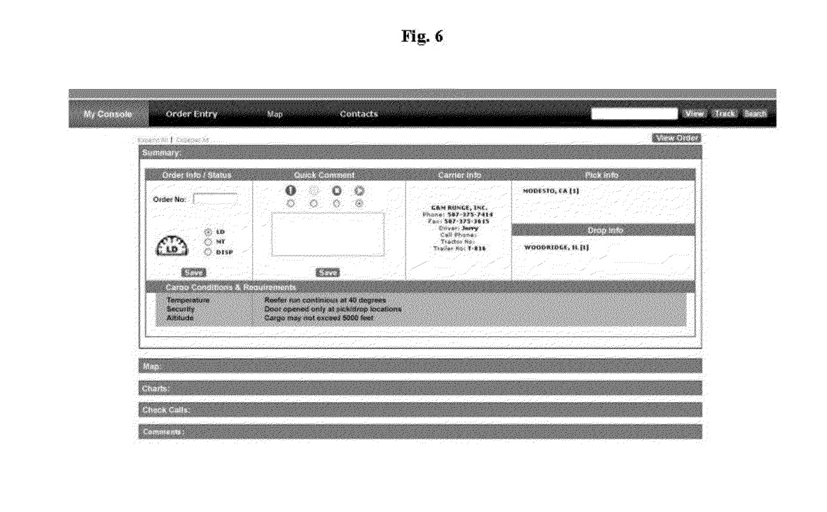

Referring to FIG. 6, in a particular embodiment, a shared portal includes a console that allows a user to interact with an order from a list of orders to retrieve an order detail screen. In this embodiment, an order detail screen includes a summary, a map, charts, check calls, and comments for the order. Further in this embodiment, an order detail summary includes order status, carrier information, driver information, pick up information, drop off information, and requirements for the cargo environmental conditions.

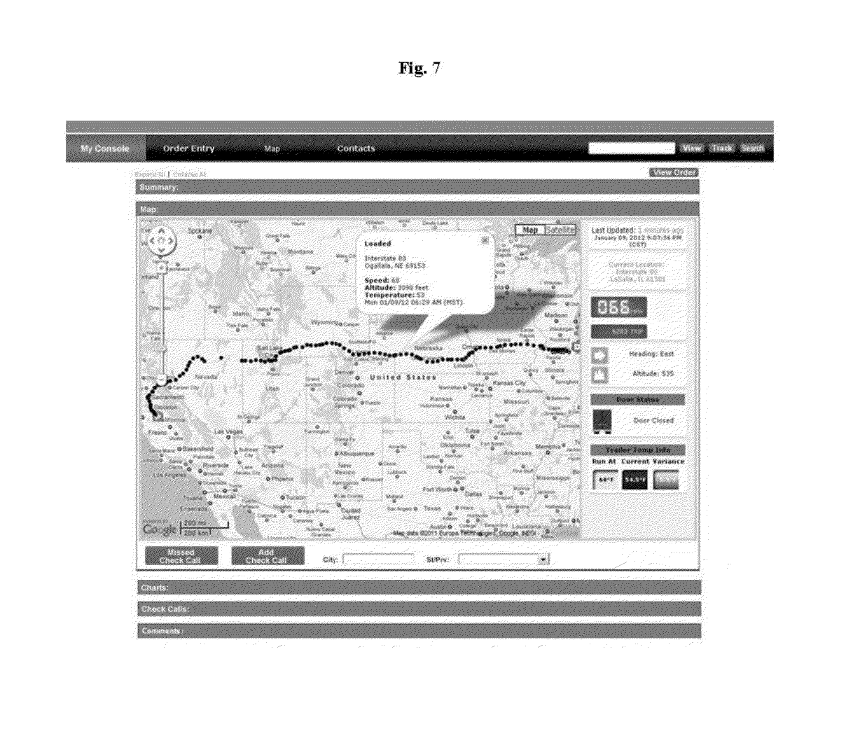

Referring to FIG. 7, in a particular embodiment, a shared portal includes a console that allows a user to interact with an order from a list of orders to retrieve an order detail screen. In this embodiment, an order detail screen includes a summary, a map, charts, check calls, and comments for the order. Further in this embodiment, an order detail map includes a current location, a current speed, a current temperature, a current heading, a current altitude, and a current door status. The map in this particular embodiment includes a breadcrumb trail of telemetry data, wherein each point in the trail optionally displays historic data including location, speed, altitude, temperature, and the time/date the data was recorded.

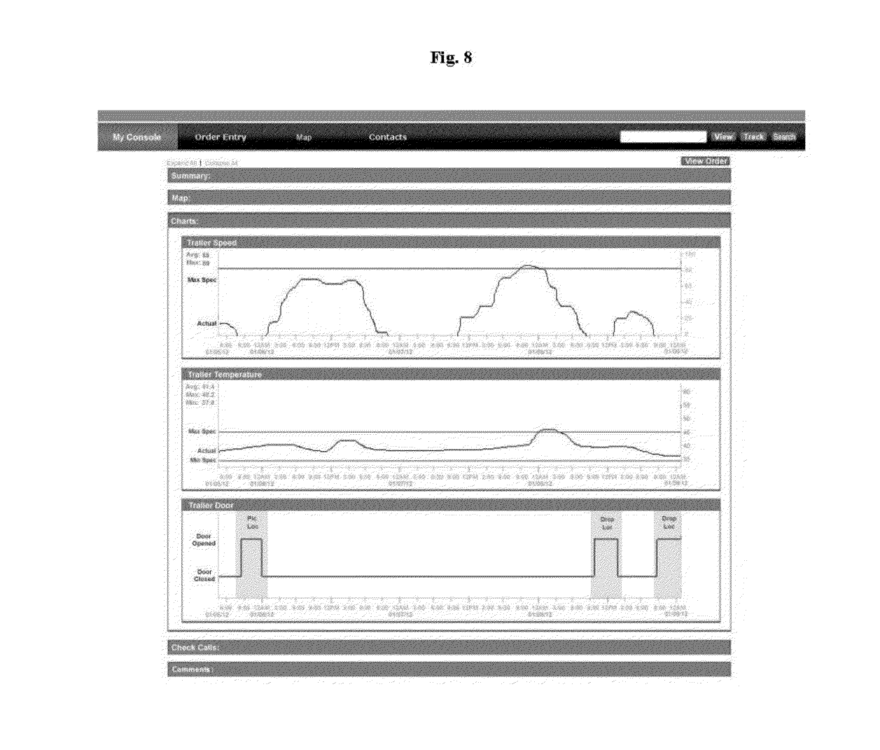

Referring to FIG. 8, in a particular embodiment, a shared portal includes a console that allows a user to interact with an order from a list of orders to retrieve an order detail screen. In this embodiment, an order detail screen includes a summary, a map, charts, check calls, and comments for the order. Further in this embodiment, order detail charts include a graph of telemetry data; in this case, freight transport equipment speed over time. Further in this embodiment, order detail charts includes graphs of freight integrity data; in this case, trailer temperature and trailer door status over time.

Referring to FIG. 9, in a particular embodiment, a shared portal includes a console that allows a user to interact with an order from a list of orders to retrieve an order detail screen. In this embodiment, an order detail screen includes a summary, a map, charts, check calls, and comments for the order. Further in this embodiment, order detail check calls include an interactive timeline of check calls, wherein for each check call a load status, truck location, date/time, speed, temperature, door status, next destination, distance to next destination, and next destination date/time are displayed.

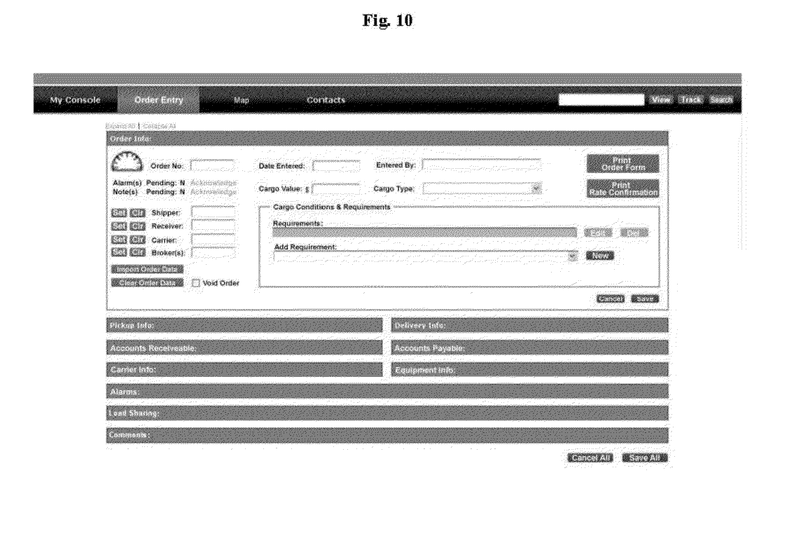

Referring to FIG. 10, in a particular embodiment, a shared portal includes a GUI for order entry. In this embodiment, an order entry GUI allows entry of order information; pick up/delivery information, accounts receivable/payable information, carrier information, equipment information, alarms/notifications, load sharing, and comments. Further in this embodiment, order information includes order number, date entered, person entering information, shipper, receiver, carrier, broker or brokers, required cargo environmental conditions, and configured alarms/notifications.

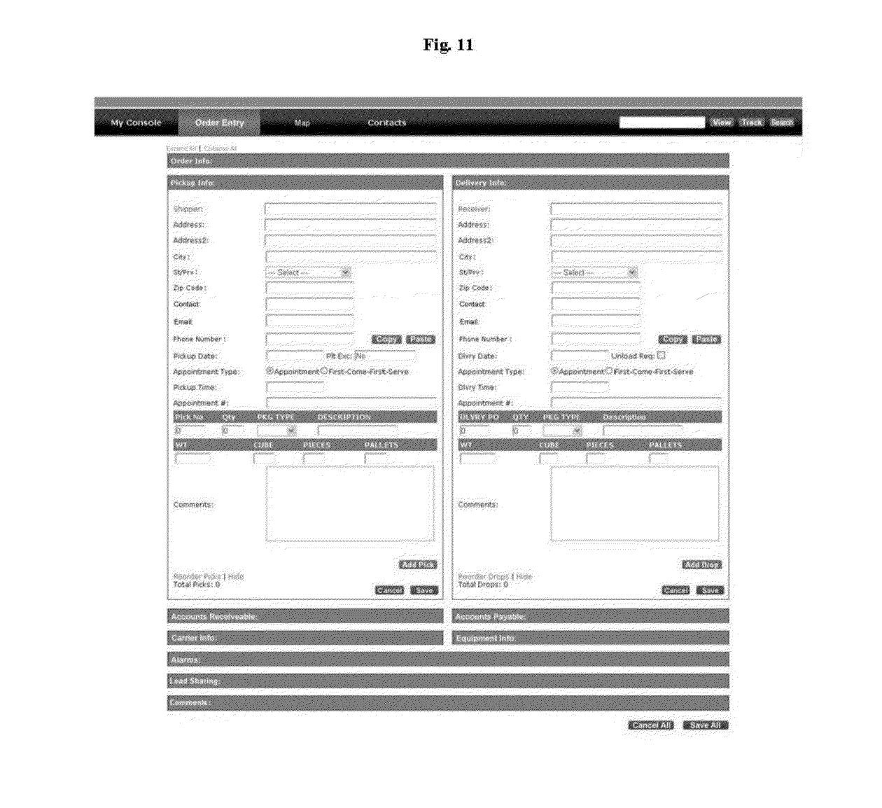

Referring to FIG. 11, in a particular embodiment, a shared portal includes a GUI for order entry. In this embodiment, an order entry GUI allows entry of order information; pick up/delivery information, accounts receivable/payable information, carrier information, equipment information, alarms/notifications, load sharing, and comments. Further in this embodiment, pick up/delivery information includes shipper, shipper address, pick up date, pick up time, and freight information as well as receiver, receiver address, delivery date, delivery time, and freight information.

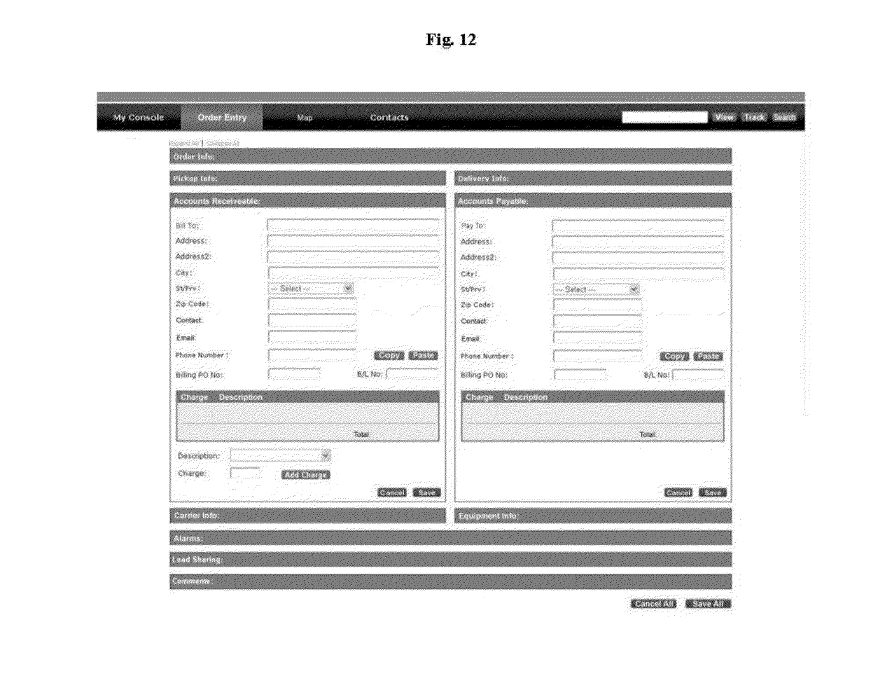

Referring to FIG. 12, in a particular embodiment, a shared portal includes a GUI for order entry. In this embodiment, an order entry GUI allows entry of order information; pick up/delivery information, accounts receivable/payable information, carrier information, equipment information, alarms/notifications, load sharing, and comments. Further in this embodiment, accounts receivable/payable information includes party to bill to, billing address, billing PO number, charge, and charge description as well as party to pay to, and payment information.

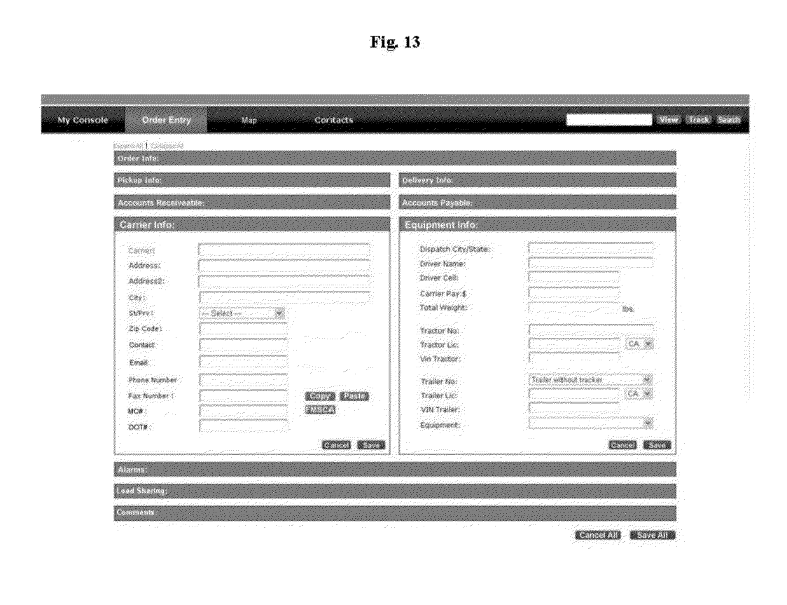

Referring to FIG. 13, in a particular embodiment, a shared portal includes a GUI for order entry. In this embodiment, an order entry GUI allows entry and viewing of: order information, pick up/delivery information, accounts receivable/payable information, carrier information, equipment information, alarms/notifications, load sharing, and comments. Further in this embodiment, carrier information includes carrier name, carrier address, carrier contact information, carrier MC number, and carrier DOT number. Still further in this embodiment, equipment information includes dispatch city/state, driver name, driver mobile phone number, carrier pay rate, total weight, tractor number, tractor license number and state, tractor VIN, trailer number, trailer license number and state, trailer VIN, and type of equipment.

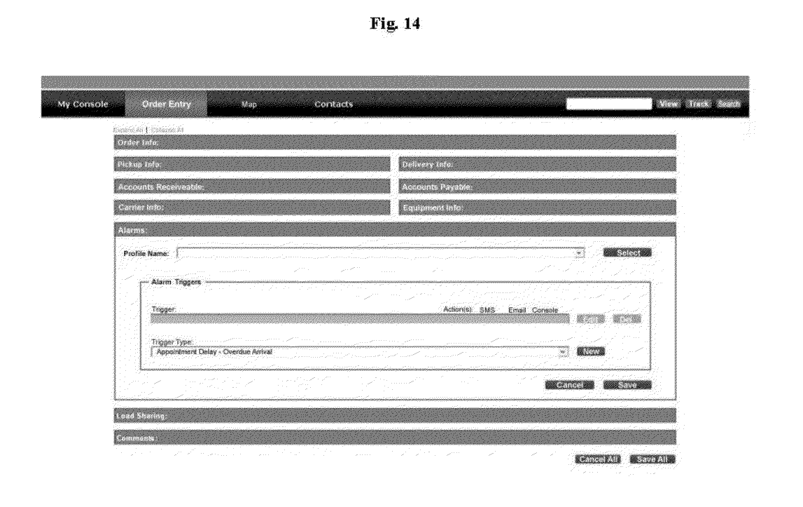

Referring to FIG. 14, in a particular embodiment, a shared portal includes a GUI for order entry. In this embodiment, an order entry GUI allows entry of order information; pick up/delivery information, accounts receivable/payable information, carrier information, equipment information, alarms/notifications, load sharing, and comments. Further in this embodiment, alarm/notification information includes trigger, trigger type, and action (e.g., SMS, email, notification via console, etc.).

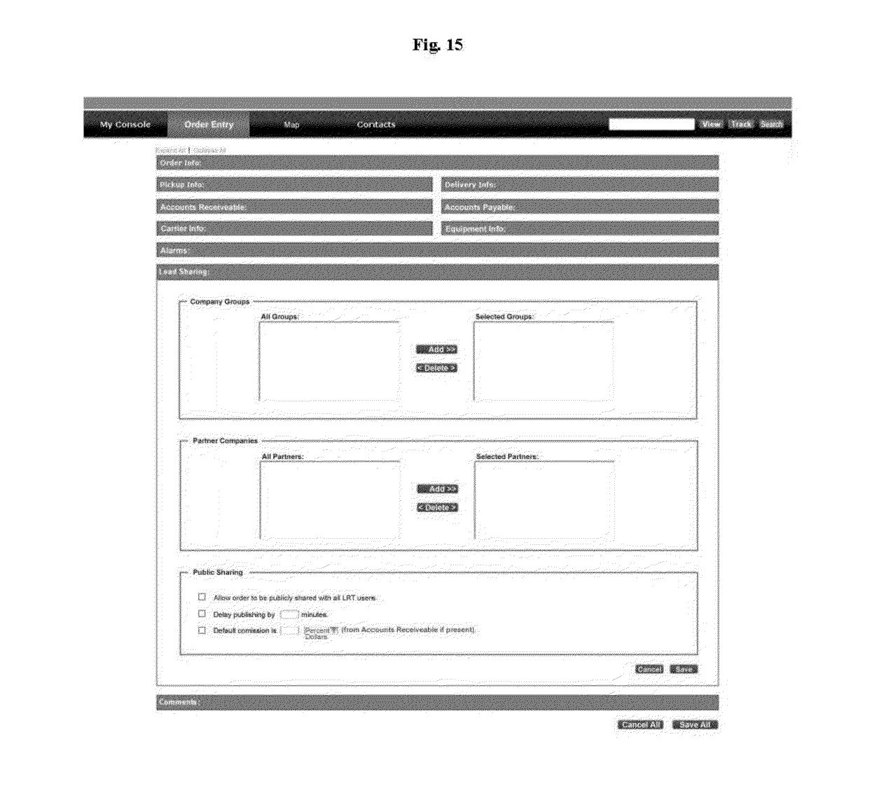

Referring to FIG. 15, in a particular embodiment, a shared portal includes a GUI for order entry. In this embodiment, an order entry GUI allows entry of order information; pick up/delivery information, accounts receivable/payable information, carrier information, equipment information, alarms/notifications, load sharing, and comments. Further in this embodiment, load sharing information includes company groups to share with, partner companies to share with, and public sharing options.

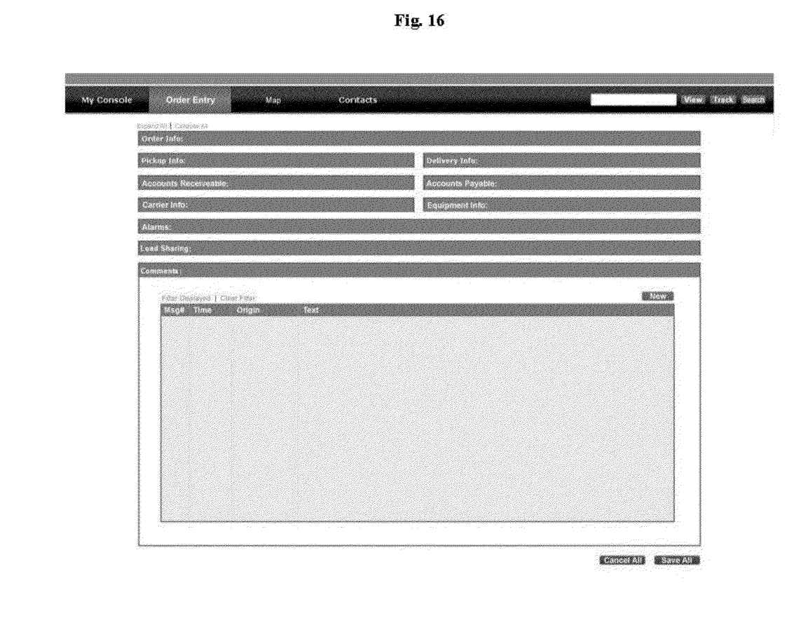

Referring to FIG. 16, in a particular embodiment, a shared portal includes a GUI for order entry. In this embodiment, an order entry GUI allows entry of order information; pick up/delivery information, accounts receivable/payable information, carrier information, equipment information, alarms/notifications, load sharing, and comments. Further in this embodiment, comments include a message, a time, and an origin.

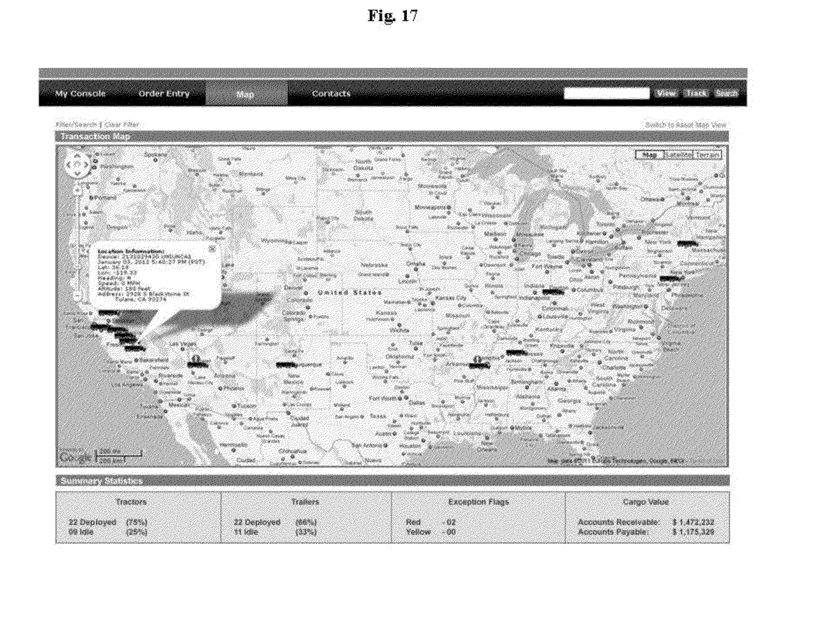

Referring to FIG. 17, in a particular embodiment, a shared portal includes a map displaying telemetry data for freight transport orders with which the user is involved. In this embodiment, a map indicates the number of tractors and trailers deployed to the orders and for each order, a breadcrumb trail of date illustrating the path of the freight transport equipment. Further in this embodiment, each breadcrumb trail is composed of a plurality of individual telemetry data reports, each of which optionally indicates the transmitting device, date of transmission, time of transmission, latitude, longitude, heading, speed, altitude, and nearest street address.

In some embodiments, a shared portal further offers access to administrative software modules to facilitate management of assets, users, contacts, partnerships, alarms/notifications, and the like associated with a particular user or entity. In further embodiments, a shared portal further offers access to administrative software modules to customize the application.

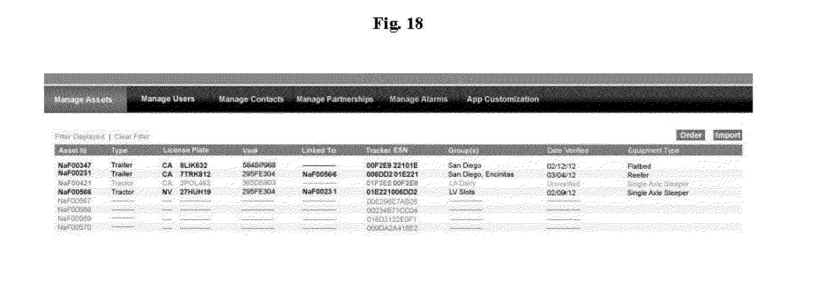

Referring to FIG. 18, in a particular embodiment, a shared portal includes a GUI for management and/or administration of information associated with a particular account. In this embodiment, a management GUI provides a filtered list of assets associated with the account. Further in this embodiment, for each asset, an asset ID, a type, a license plate number, a VIN number, a linkage, a tracker device identification (ESN), a group, a date of last inspection/verification of tracker device, and an asset type is displayed.

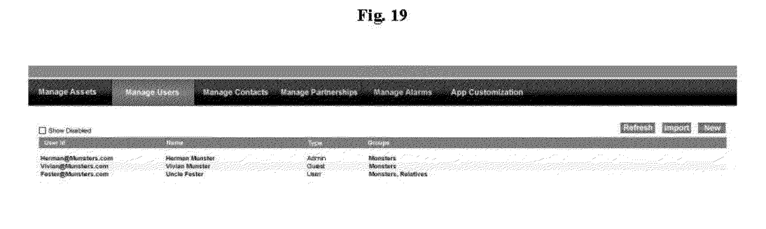

Referring to FIG. 19, in a particular embodiment, a shared portal includes a GUI for management and/or administration of information associated with a particular account. In this embodiment, a management GUI provides a filtered list of users. Further in this embodiment, for each user, a user ID, a name, a user type, and a group is displayed.

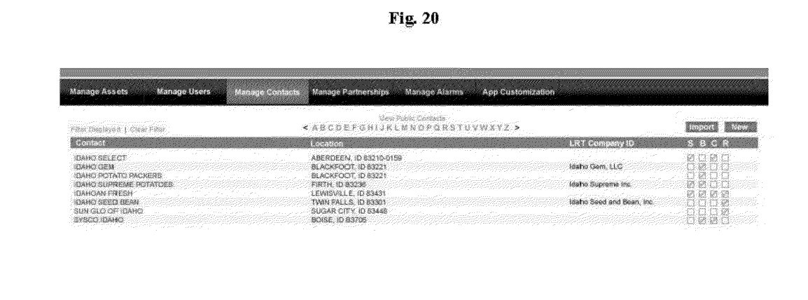

Referring to FIG. 20, in a particular embodiment, a shared portal includes a GUI for management and/or administration of information associated with a particular account. In this embodiment, a management GUI provides a filtered list of contacts. Further in this embodiment, for each contact, a name, a location, and a company association is displayed.

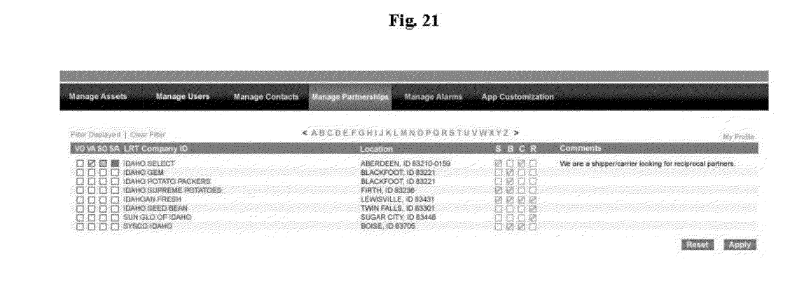

Referring to FIG. 21, in a particular embodiment, a shared portal includes a GUI for management and/or administration of information associated with a particular account. In this embodiment, a management GUI provides a filtered list of partnerships and potential partnership companies. Further in this embodiment, for each partnership, organization user ID, a location, and comment are displayed.

In some embodiments, a shared portal described herein is optionally searchable, sortable, and filterable based on partnerships. In further embodiments, a user optionally views only information (including orders) with which a partner is involved. In some embodiments, partnerships are created by association of two or more organization-level (e.g., company-level) user IDs. In further embodiments, partnerships are created electronically by a process involving an invitation or request from a first user (authorized by a first organization) followed by a response from a second user (authorized by a second organization).

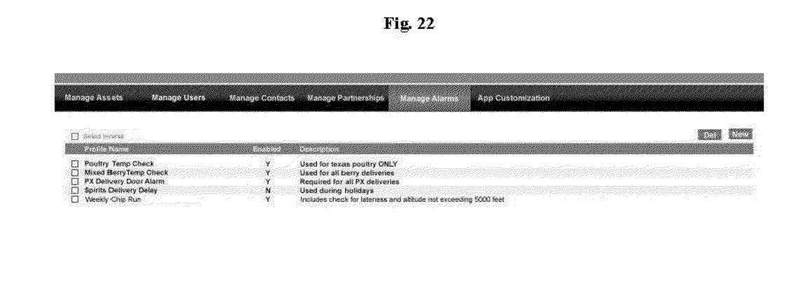

Referring to FIG. 22, in a particular embodiment, a shared portal includes a GUI for management and/or administration of information associated with a particular account. In this embodiment, a management GUI provides a filtered list of saved alarm profiles. Further in this embodiment, for each alarm, a name, an enabled flag, and a description is displayed.

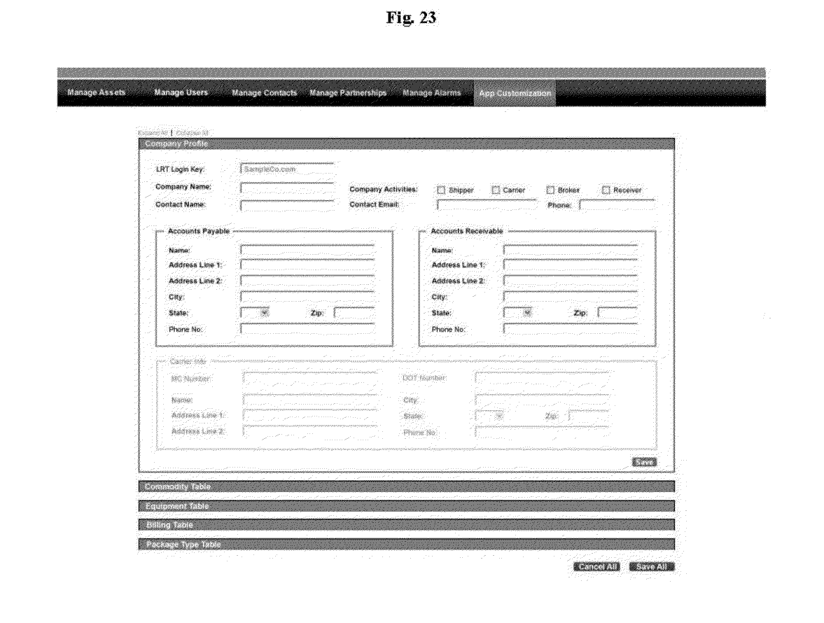

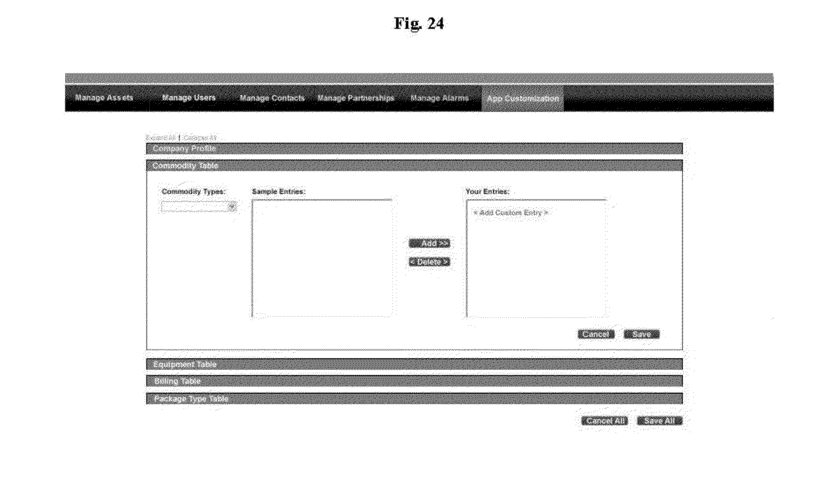

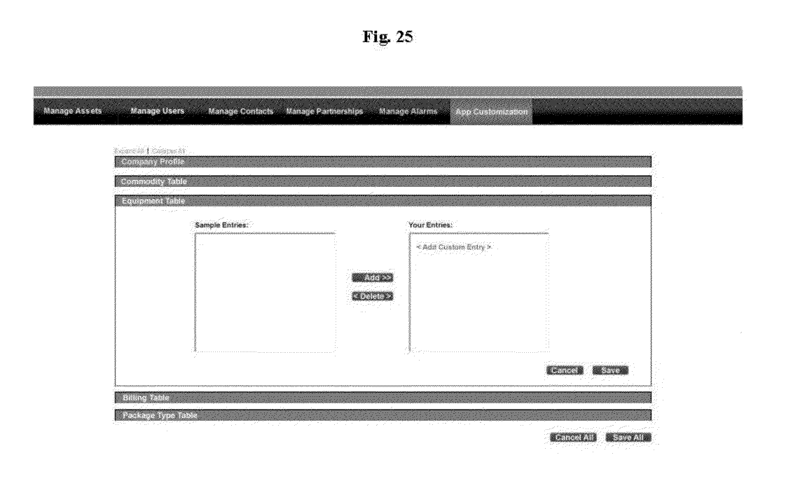

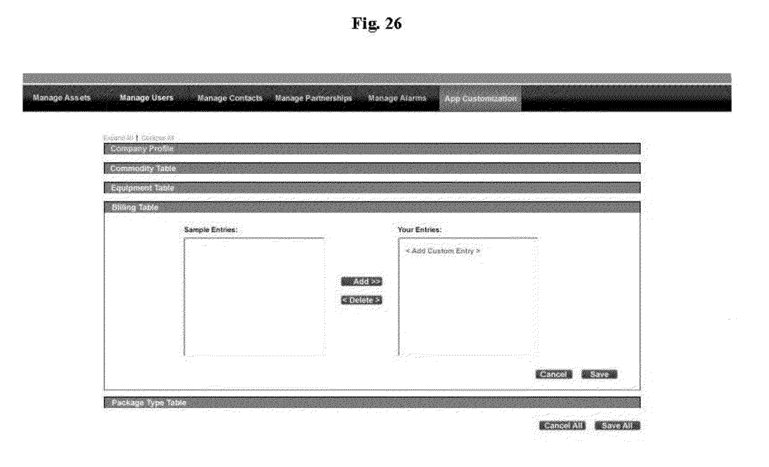

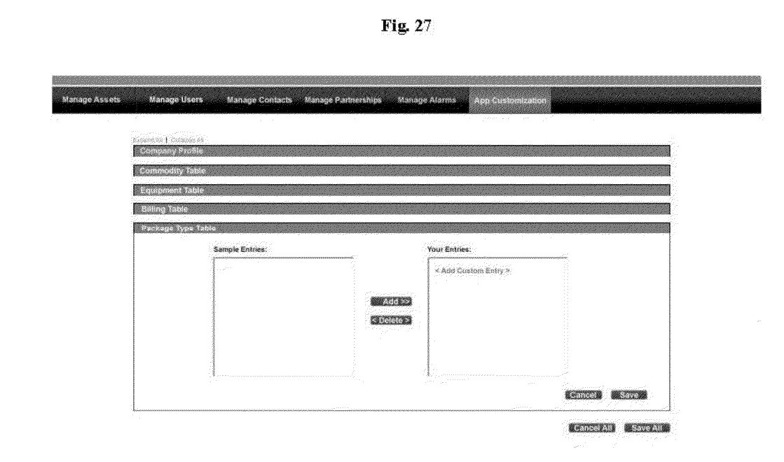

Referring to FIGS. 23-27, in a particular embodiment, a shared portal includes a GUI providing access to tools to customize the portal and account information configured within the portal. In this embodiment, customization tools allow tuning of a company profile, configuration of freight commodities, configuration of equipment, configuration of billing, and configuration of package types.

### Digital Processing Device

In some embodiments, the systems, devices, software, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the systems, devices, software, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, devices, software, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

The methods, software, media, and systems disclosed herein comprise at least one computer processor, or use of the same. The computer processor may comprise a computer program. A computer program may include a sequence of instructions, executable in the digital processing device's CPU, written to perform a specified task. Computer readable instructions may be implemented as program modules, such as functions, features, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. A computer program may comprise one sequence of instructions. A computer program may comprise a plurality of sequences of instructions. A computer program may be provided from one location. A computer program may be provided from a plurality of locations. A computer program may include one or more software modules. A computer program may include, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

A computer program may include a web browser plug-in. In computing, a plug-in may be one or more software components that add specific functionality to a larger software application. Makers of software applications may support plug-ins to enable third-party developers to create abilities which extend an application, to support easily adding new features, and to reduce the size of an application. When supported, plug-ins may enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight® , and Apple® QuickTime®. The toolbar may comprise one or more web browser extensions, add-ins, or add-ons. The toolbar may comprise one or more explorer bars, tool bands, or desk bands.

In view of the disclosure provided herein, those of skill in the art will recognize that several plug-in frameworks may be available that enable development of plug-ins in various programming languages, including, by way of non-limiting examples, C++, Delphi, Java™, PHP, Python™, and VB .NET, or combinations thereof.

Web browsers (also called Internet browsers) may be software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. The web browser may be a mobile web browser. Mobile web browsers (also called mircrobrowsers, mini-browsers, and wireless browsers) may be designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

The systems, devices, software, and methods disclosed herein include, in various embodiments, software, server, and database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system for freight carrier verification comprising:
a. a database of freight carriers, freight transport equipment, and operators;
b. a database of freight transport orders, each order comprising an associated carrier;
c. a device attached to, associated with, or operably connected to freight transport equipment and configured to transmit freight transport equipment information;
d. a device attached to, associated with, or operably connected to freight transport equipment and configured to transmit operator biometric information; and
e. a software module configured to generate a shared portal that displays information associated with the orders including the carrier, the equipment, the operator, and the biometric information, wherein the portal is accessible by all users associated with an order.

2. (canceled)

3. (canceled)

4. (canceled)

5. (canceled)

6. (canceled)

7. The system of claim 1, provided that the freight transport equipment information comprises telemetry information.

8. The system of claim 7, provided that the telemetry information comprises at least one of: location, speed, direction, altitude, freight temperature, freight humidity, freight atmospheric pressure, freight vibration, freight shock, freight ambient light, and door status.

9. (canceled)

10. (canceled)

11. The system of claim 1, provided that the portal displays a projected arrival date and time.

12. (canceled)

13. The system of claim 1, provided that at least one device is configured to transmit operator biometric information that comprises a fingerprint reader.

14. The system of claim 1, provided that the portal displays the method by which each device configured to transmit freight transport equipment information is attached to freight transport equipment.

15. The system of claim 1, provided that the portal displays the last inspection date for each device configured to transmit freight transport equipment information.

16. (canceled)

17. (canceled)

18. (canceled)

19. The system of claim 1, further comprising a software module for defining a geofence associated with at least one of: a freight pick-up location, a way point, and a freight drop-off location.

20. The system of claim 19, provided that a geofence is utilized to automatically update the status of freight transport equipment.

21. The system of claim 20, provided that a status of freight transport equipment is at least one of: available, booked, dispatched, arrived at pick up, loaded, arrived at drop off, drop, and empty.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. A non-transitory computer readable storage media encoded with a computer program including instructions executable by a processor to create a software application comprising:
(a) a software module configured to read data generated by a sensor attached to a freight transport equipment;
(b) a software module configured to read data stored in a database of freight carriers, freight transport equipment or operators; and
(c) a software module configured to read data stored in a database of freight transport orders, provided that each order comprises an associated carrier.

75. (canceled)

76. (canceled)

77. The media of claim 74, provided that the software application further comprises a software module configured to identify a biometric feature of a user.

78. The media of claim 77, provided that the biometric feature comprises a fingerprint.

79. The media of claim 77, provided that the biometric feature comprises an iris.

80. The media of claim 77, provided that the biometric feature comprises a face.

81. (canceled)

82. (canceled)

83. (canceled)

84. (canceled)

85. (canceled)

86. (canceled)

87. (canceled)

88. (canceled)

89. (canceled)

90. The media of claim 74, provided that the software application further comprises a software module configured to update a status of the freight transport equipment periodically or real-time.

91. The media of claim 90, provided that the status of freight transport equipment comprises one or more of: available, booked, dispatched, arrived at pick up, loaded, arrived at drop off, drop, and empty.

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. The media of claim 74, provided that the freight transport equipment information comprises telemetry information.

105. The media of claim 104, provided that the telemetry information comprises at least one of: location, speed, direction, altitude, freight temperature, freight humidity, freight atmospheric pressure, freight vibration, freight shock, freight ambient light, and door status.

106.-154. (canceled)

155. A computer-implemented system for freight carrier verification comprising:
a. a database of freight carriers, freight transport equipment, and operators, wherein freight transport equipment information includes freight transport equipment location information, freight transport equipment status information and freight integrity information;
b. a database of freight transport orders, each order comprising an associated carrier;
c. a device attached to, associated with, or operably connected to freight transport equipment and configured to transmit freight transport equipment information;
d. a device attached to, associated with, or operably connected to freight transport equipment and configured to transmit operator biometric information;
e. a software module configured to verify: (1) operator integrity by matching biometric data collected at various points throughout transit against verified operator records and (2) equipment integrity through hardware attached to the transport equipment;
f. a software module configured to generate a shared portal that displays information associated with the orders including the carrier, the equipment, the operator, and the biometric information, wherein the portal is accessible by all users associated with an order;
g. a software module configured to define a geofence associated with at least one of:
a freight pick-up location, a way point, and a freight drop-off location, wherein the geofence is utilized to automatically update the status of freight transport equipment;
h. a software module for scoring individuals or entities including carriers, operators, brokers, shippers, receivers, and the like associated with the tracking of the carry-out of freight transport orders;
i. a software module for creating and displaying scorings and reviews on individuals and entities in a shared portal, wherein scorings and reviews are accessible to all users for choosing of entities for future orders.
